(19) United States
(12) Patent Application Publication
(10) Pub. No.: US 2023/0034883 A1
(43) Pub. Date: Feb. 2, 2023

(54) MULTI-FUNCTIONAL HYBRID MATERIAL BASED ON NATURAL CLAYS FOR ENVIRONMENTAL RECOVERY AND BIO-REMEDIATION

(71) Applicants: CONSIGLIO NAZIONALE DELLE RICERCHE (60%), Roma (IT); UNIVERSITA' DEGLI STUDI DI MESSINA (40%), Messina (IT)

(72) Inventors: Maria Rosaria Plutino, Roma (IT); Simone Cappello, Roma (IT); Giuseppe Sabatino, Messina (IT); Giulia Rando, Messina (IT)

(73) Assignees: CONSIGLIO NAZIONALE DELLE RICERCHE (60%), Roma (IT); UNIVERSITA' DEGLI STUDI DI MESSINA (40%), Messina (IT)

(21) Appl. No.: 17/757,567

(22) PCT Filed: Dec. 15, 2020
(86) PCT No.: PCT/IB2020/061967

§ 371 Date: Jun. 17, 2022

(30) Foreign Application Priority Data
Dec. 19, 2019 (IT) 102019000024802

(51) Int. Cl. B01J 20/12; B01J 20/26; B01J 20/28; C09K 3/32

(52) U.S. Cl. CPC B01J 20/12; B01J 20/267; B01J 20/28045; C09K 3/32; B01J 2220/4887

(57) ABSTRACT

A multi-functional hybrid material based on natural clays for environmental bio-remediation and recover), is disclosed. In particular, the invention discloses the design and development of appropriately functionalized nanohybrid materials starting from nanostructured clays and the subsequent study of the absorbent properties in relation to hydrocarbons, heavy metals, chemical pollutants, oils, particulate, and microplastics. These nanomaterials were prepared in order to remove the hydrocarbon pollutants (for example oil) and metal pollutants in natural matrices (marine environment), with potential applications in the field of environmental remediation.

### FIELD OF THE INVENTION

The present invention relates to a multi-functional hybrid material based on natural clays for recovery and environmental bio-remediation (project known as “ArgiNaRe”).

### BACKGROUND ART

Over recent decades, the problem of pollution of the water resources of our planet, in particular of the sea, which constitutes 97% of the total water reserves, has proved particularly urgent, since the presence of chemical substances, solid wastes, and microplastics in the marine environment is very dangerous for the survival of numerous living species and for human health.

The presence of chemical substances in the sea, such as hydrocarbons, metals, chlorinated solvents, phosphates, plastics, and microplastics can have anthropic and natural origins. In the first case, said pollutants can originate from phenomena such as the release of industrial and civil wastewater into the sea, from accidental spillages of oil due to mishaps during the transportation thereof on board large tankers, from agriculture due to the absorption by the soil and of the water table of species such as water-soluble pesticides and fertilizers. In the second case, their presence is caused, meanwhile, by atmospheric and seasonal events, such as landslides and floods. According to statistics, it has been found that only 12% of marine pollution is attributable to maritime transport, while 44% comes from the land and 33% from the air.

In more detail, marine pollution can be classified as follows:
off-shore pollution: this comprises all the pollution which occurs far away from the coast, very often caused by spillages during the washing of the tanks or by the release of bilge from large vessels, from naval accidents or accidents on drilling platforms;
shore pollution: this is the most harmful and dangerous form of pollution because it is very difficult to eradicate due to the shallow waters; the various units designated to providing pollutant recovery services, and likewise the such various devices, such as skimmers, are unable to take action, while manual removal through human intervention has proved fundamental;
underwater pollution: which usually occurs following a fire (such as, for example, that of the “Haven” oil tanker in the Gulf of Genoa), following which the light component of the hydrocarbon evaporates and the heavy component heavy precipitates, depositing on the seabed.

In the case of hydrocarbon substances, the pollution can be systematic or accidental. Nevertheless, it has been determined that only 10% of the hydrocarbons which contaminate the seas come from accidental spills. The rest come from chronic sources, such as polluting particles falling back down from the atmosphere, from natural seepage, from the washing away of the mineral oils dispersed in the environment, leaks from refineries or drilling systems on open-sea platforms and, above all, from tankers (oil and otherwise) discharging ballast water into the sea (which amounts to 20% of the total pollution). Crude oil is the oil in the state in which it is extracted from the oil fields, while the derivative materials (which are obtained by refining crude oil) include fuels and fuel oil. According to biogenic theory, oil is a non-renewable fossil fuel, composed essentially of hydrocarbons, which is derived from the decomposition of plant and animal organisms which has taken place within an anaerobic environment, following the continuous accumulation thereof in the subsoil for millions of years inside rocks which gradually form.

From a chemical viewpoint, crude oil is an emulsion of hydrocarbons and other impurities with water, typically 40% cycloalkanes, 30% alkanes, 25% aromatic hydrocarbons, and 5% other substances.

The light components represent 95% of the soluble fraction of oil and are constituted of aliphatic hydrocarbons (alkanes and cycloalkanes) containing up to 10 carbon atoms, characterized by low solubility in water (a few mg/l), and of monoaromatic hydrocarbons (benzene, toluene and xylene), with a higher solubility than the aliphatic ones. They are characterized by: (i) a maximum boiling point of 150° C.; (ii) rapid and complete evaporation, generally within a day.

The medium components are aliphatic hydrocarbons containing from 11 to 22 carbon atoms (highly biodegradable alkanes whose concentration over time is a measurement of the degradation of the spilled oil), diaromatic hydrocarbons (naphthalene) and polyaromatic hydrocarbons (phenanthrene, anthracene, etc.). They are characterized by: (i) boiling point comprised between 150 and 400° C.; (ii) low evaporation speed, which reaches several days (certain residues do not evaporate at room temperature environment); (iii) low solubility in water (a few mg/1).

Lastly, the heavy components are hydrocarbons containing 23 or more carbon atoms in addition to waxes, asphaltenes, and polar compounds. They are characterized by: (i) minimum loss through evaporation; (ii) minimum solubility; (iii) long-term persistence in sediment in the form of lumps of tar or asphalt layers. They are the most persistent compounds and are characterized by low degradation speed.

The main physical properties which influence the behaviour and the persistence of hydrocarbons in the sea are: the specific gravity (relative density), the evaporation tendency (which describes their volatility), the viscosity (which describes the creep resistance) and the pour point [i.e. the temperature below which the hydrocarbon does not pour any more and assumes a semisolid state. The value thereof essentially depends on the wax and asphaltene content thereof]. Once the physical characteristics of hydrocarbons had been considered, a classification known as the API (American Petroleum Institute) was established and accepted internationally, which subdivides the crude oils into four classes according to their density in °API (°API=(141.5/relative density)−131.5). By combining the API classification and the empirical concept of persistence of oil in the sea, the hydrocarbons are subdivided mainly into persistent (crude oils, fuel oils, and bitumens) and non-persistent (benzine, kerosene, and diesel). On the basis of this classification, four main groups of crude oils and materials can be distinguished, as shown in the table below [http://www.seaforecast.cnr.it/sosbonifacio/index.php/Il-Progetto/inquinamento-marino-da-idrocarburi.html]:

| Group | Specific gravity | °API density | Persistence | Example |
|---|---|---|---|---|
| Group I | <0.8 | >45 | Non-persistent | Petrol, naphtha, kerosene |
| Group II | 0.8-0.85 | 35-45 | Shortly persistent | Diesel, Abu Dhabi Crude |
| Group III | 0.85-0.95 | 17.5-35 | Intermediate persistent | Arabian Light Crude |
| Group IV | >0.95 | <17.5 | Very persistent | Heavy Fuel Oil, |
| | | | | Venezuelan Crude Oils |

On the basis of this classification, one notes that the lower the density of an oil is (expressed as °API), the more noxious the oil is for the marine ecosystem.

When floating on water, crude oil expands rapidly into an extensive slick, forming layers of different thicknesses, which the currents and the winds carry far off and split into ‘banks’, positioned parallel to the direction of the prevailing winds.

The composition of the mixture of oils spilled in the sea evolve over time depending on the chemical-physical characteristics of the hydrocarbons and of the weathering processes, i.e. of the atmospheric agents, such as for example, evaporation, dispersion, dissolution, oxidation, emulsification, spreading, biodegradation, sedimentation.

Through these processes, the composition of the mixture in the sea changes rapidly in the first one or two days following the spill due to the evaporation of the more volatile fractions, and then slows as said processes stabilise, proceeding towards a thermodynamic balance with the environmental conditions.

Some components penetrate the upper layers of the water, where they produce very harmful effects on marine organisms and are slowly oxidated biochemically through the action of bacteria, fungi, and algae. The heavier fractions roam, meanwhile, on the surface of the sea, until they form virtually unbiodegradable lumps which sink slowly down to the seabed. The time required for this degradation process varies according to the conditions of the sea, the meteorological conditions, the temperature and of the type of pollutant.

At first, the most significant processes are dispersion, evaporation, emulsification and dissolution, while biodegradation and sedimentation phenomena occur later on.

Therefore, one can understand how much interventions immediately after the accidental event or not, are crucial to minimise damage to the marine environment, above all to facilitate the recovery, where possible, of the ecosystems. From this perspective, the interventions can have three objectives: (i) recovery of the polluting substances, (ii) remediation of the sites and (iii) protection of the most sensitive areas.

### Environmental Recovery Methods:

Management of the emergency following an oil spill at sea can be structured into a series of strategies designed for intervention in different operating conditions.

A first strategy consists of mechanical removal, which decreases noticeably as the motion of the waves and the wind speed increase. It is advisable, indeed, if the height of the waves does not exceed 2-3 feet (0.6-0.9 m) and if the wind speed is below 9-10 knots (parameters which can also limit the safety of staff involved during operations). Furthermore, mechanical removal is not advised when the thickness of the oil film is below one thousandth of an inch.

The use of the dispersants is a widely utilised technique which requires minimal conditions to be effective. If the wind speed and the height of the waves exceed a certain limit (wind speed above 25 knots and waves height above 10 feet or 3 metres), oil and in particular the lighter components thereof disperse naturally.

Generally, the use of dispersants is limited to films with a thickness comprised between one thousandth and one hundredth of an inch, nevertheless the most recent dispersants and new techniques for the employment thereof have extended this range also to films up to 0.1 inches thick (0.25 cm). In practice, for the recovery of the contaminated zones particular instruments or substances are utilised.

Floating barriers are among the most common containment systems and they act by surrounding the oil slick, thereby preventing it reaching sensitive zones present in the vicinity. Floating barriers require a certain amount of maintenance to be re-arranged according to the direction of the current, the intensity of the motion of the waves, the movement of the tides, etc. Physical removal of the oil from the surface of the water decreases the risk and the threat of contamination for birds and mammals.

There also exist various devices for the recovery of hydrocarbons which float on the surface of the water, commonly called skimmers. These are based on different collection principles and are built to work in different operating conditions.

The most common devices are weir skimmers. These are equipped with floats which keep the mouth (intake) of the device just below the surface of the water, so as to make the material sink, to then be conveyed, by means of pumps, into a tank. The tank will act as a decantation separator and the water, which will form layers below, may be released via a valve.

Adhesion devices are also utilised, which work, precisely, on the principle of adhesion of the hydrocarbons to oleophilic surfaces. These surfaces consist of discs, drums, brushes, or cords. The adhesive surface moves through the laminal layer between the water and oil and lifts the latter, after which it flows though wiper or wringer-like systems which remove and collect the hydrocarbons.

Nevertheless, a technique which has been emerging over recent years is based on the use of absorbents and dispersants. ‘Absorbent’ means any material, whether organic, inorganic or synthetic, which removes the oil by the absorption thereof into the solid material which acts as a sponge, or by adsorption on the external surface of the material. The dispersants reduce the surface tension of the water/oil interface, thereby promoting the disintegration of the particles of oil into ever smaller parts, impairing the subsequent re-agglomeration thereof. This way, natural degradation is facilitated through the motion of the waves in the sea or through microbiological agents.

### Absorbent Materials:

The absorbent materials employed in the recovery of hydrocarbons from the sea can be classified as follows:
inert absorbent materials, which perform an absorbent action in relation to hydrocarbons and are composed of substances which are inert from a chemical and a biological viewpoint. They can be of synthetic, mineral, animal or plant origin;
non-inert absorbent materials, which perform an absorbent action in relation to hydrocarbons, but constitute non-inert substances from a chemical and a biological viewpoint. The can be of synthetic or natural origin and are insoluble in water: nevertheless, they can interact with living organisms, which is why the degree of toxicity on marine organisms must be assessed beforehand.

In Italy, the use of non-inert absorbents is governed according to the legislation set out in Annex 4 of the Italian decree dated 25 Feb. 2011, which states the “Testing methods and criteria for acceptability of the results of the tests needed to recognise suitability of non-inert absorbent materials of synthetic or natural origin”.

On the basis of the efficacy test, a material is considered acceptable, when the absorbent is able to retain at least 60% of the oil based on the weight thereof weight; on the basis of the toxicity assay, a material is considered acceptable when it does not show statistically significant toxicity effects with respect to the control.

Furthermore, in Italy, the DPN-DEC-2009-403 decree dated 31 Mar. 2009 breaks down inert absorbent materials into three categories:
absorbents of plant or animal origin (straw, cellulose fibre, cork, plant processing residues, birds' feathers);
absorbents of mineral origin (volcanic powders, perlites, vermiculite, zeolites);
absorbents of origin synthetic (polyethylene, polypropylene, polyurethane, polyester).

All the absorbents utilised, after the recovery of the oil, are disposed of by means of combustion. There are many materials being studied for their capacity to absorb oil. One of these is lignin, or ‘yolky’ wool (unwashed sheared wool), which is particularly water-repellent and capable of absorbing oils weighing up to 10 times their weight.

### Hybrid Materials and Nanofillers:

Nanotechnologies have recently been focusing on the development of nanohybrid materials and functional nanocomposites, characterized by the presence of nanometric components or nanofillers (with dimensions ranging from 100 a 0.1 nm) dispersed in a polymeric matrix, which feature increased properties or inexistent properties in both the constituent components thereof (FIG. 1).

These organic/inorganic nanohybrid materials, obtainable in different ways synthetically, can be classified as follows:
composites: mixture of materials consisting of a matrix and a micrometric dispersion,
nanocomposites: sub-micrometric (1-100 nm) mixture of materials of a similar kind,
hybrid: sub-micrometric mixture of materials of different kinds with respect to the hybrid material compound,
nanohybrids: mixture—at atomic or molecular level—of different materials with the formation of chemical bonds therebetween.

The nano-object or nanofiller is a material which has a doping or functionalizing effect on the matrix in which it is dispersed and is characterized by the fact that it has at least one of the dimensions thereof falling within the magnitude of nanometres. The properties of the organic/inorganic hybrid material depend heavily on the relationship between the organic matrix and the amount of nanofiller employed.

In particular, nano-hybrids and nanocomposites are synthesized mainly for the creation of new materials with outstanding properties, such as:
improvement of the mechanical properties, such as resistance to impacts, cuts, and abrasion;
resistance to chemical agents which could wear the structures of the composites;
electric conductibility (of current interest in the field of the smart fabrics) or thermal conductibility (in the case of resistance to extreme environments);
permeability, selective and otherwise, to gas and liquid;
capacity of encapsulating active or medical ingredients (materials for medical prostheses containing drugs or growth factors);
flame-resistance.

All this is also possible through the use of small amounts of nanoreinforcers or nanofillers, with respect to the normal amounts of bulk fillers utilised to obtain certain features.

Nanofillers are classified as follows:
one-dimensional, in the form of plates, sheets, and shells;
two-dimensional, such as nanotubes and nanofibres with a diameter below 0.1 μm;
three-dimensional, i.e. iso-dimensional nanoparticles, such as those of silica nanospheres.

Nanofillers are inserted into the polymer in concentrations amounting to approximately 1%-10% (by weight). The are also added in the presence of conventional fillers and additives or reinforcers, and improve the chemical and/or physical resistance of the finished material.

To address the environmental issues described above and the problems linked to the continuous development of new materials, an object of the present invention is therefore to provide a method for removing hydrocarbon pollutants (for example, oil) which is effective, has minimal impact on the marine ecosystem, and hopefully also finds potential application in the field of environmental remediation.

### SUMMARY OF THE INVENTION

Said object has been achieved by a functionalized hybrid material as stated in claim 1, as well as a process for its preparation.

In another aspect, the present invention concerns the use of this functionalized hybrid material as an absorbent substrate for hydrocarbons, heavy metals, chemical pollutants, oils, particulate, and microplastics, for environmental remediation and recovery.

In a further aspect, the present invention concerns a product for environmental remediation and recovery, comprising said functionalized hybrid material.

In an additional aspect, the present invention concerns a method for environmental remediation and recovery through the use of the functionalized hybrid material and the product comprising the same.

### BRIEF DESCRIPTION OF THE FIGURES

The characteristics and advantages of the present invention will be apparent from the following detailed description, the embodiments provided as illustrative and non-limiting examples, and the annexed figures, wherein:

FIG. 1 shows a schematic illustration of possible nanocomposites and nanohybrids,

FIG. 2 shows a schematic illustration of a sectional view of Kaolinite, Illite, Montmorillonite and Chlorite, in order to highlight the structural differences thereof,

FIG. 3 shows a map of the areas of provenience of the samples of the Sicilian clays employed in the examples,

FIG. 4 shows macrosomic images of the Sicilian clays employed in the examples,

FIG. 5 shows macrosomic images of the pure clays employed in the examples,

FIG. 6 shows a reaction scheme for the formation of the sol-clay hybrids and GPTMS,

FIG. 7 shows a formation scheme for the clay hybrid coatings a base sol-gel on fabric,

FIG. 8 shows an image of the control system (sea water with oil, SW+OIL) at the start of the experimental time (T₀), as shown in Example 2,

FIG. 9 shows images corresponding to the systems under examination in Example 2, after 7 days of experimentation (T_{F}). The images refer to the samples of clay, whether functionalized with KOH or not, both as a pure substrate and modified with “GPTMS” and “GPTMS and C16”. The asterisks (*) and the frame show the systems in which the COD was measured, while the double asterisk (**) shows the systems in which GC-FID measurements were performed,

FIG. 10 shows images corresponding to the systems under examination in Example 2, after 7 days of experimentation (T_{F}). The images refer to the samples of clay whether functionalized with KOH or not, both as a pure substrate and modified with “GPTMS” and “GPTMS and C16”. The asterisks (*) and the frame show the systems in which the COD was measured,

FIG. 11 shows images corresponding to the systems under examination (fabrics) in Example 2, after 7 days of experimentation (T_{F}). The images refer to the fabrics impregnated with the clays (functionalized without KOH) modified with “GPTMS and C16”. The asterisks (*) and the frame show the systems in which the COD was measured,

FIG. 12 shows images corresponding to the systems under examination (fabrics) in Example 2, after 7 days of experimentation (T_{F}). The images refer to the fabrics impregnated with the clays (functionalized with KOH) and modified with “GPTMS” and “GPTMS and C16”. The asterisks (*) and the frame show the systems in which the COD was measured,

FIG. 13 shows images corresponding to the systems under examination (fabrics) in Example 2, after 7 days of experimentation (T_{F}). The images refer to the fabrics impregnated with the suspended particles of clay (functionalized without KOH) and modified with “GPTMS”. The asterisks (*) and the frame show the systems in which the COD was measured,

FIG. 14 shows images corresponding to the systems under examination in Example 2, in the case of the Sicilian clays,

FIG. 15 shows a comparison of the gas-chromatograms obtained from the samples under examination in Example 2. In particular, GC-FID profiles were compared between the control (Blank, outermost line), Lipari 1+GPTMS+C16+KOH (innermost line) and Lipari 4+GPTMS+KOH (intermediary line),

FIG. 16 shows a comparison between the XRD spectra of the pure Lipari 1 clay and of the corresponding functionalized version, as shown in Example 2,

FIG. 17 shows a comparison between the XRD spectra of the pure Lipari 4 clay and of the corresponding functionalized version, as shown in Example 2,

FIG. 18 shows a comparison between the XRD spectra of the pure Montmorillonite Na clay and of the corresponding functionalized version, as shown in Example 2, and

FIG. 19 shows a comparison between the XRD spectra of the pure Montmorillonite clay and of the corresponding functionalized version, as shown in Example 2.

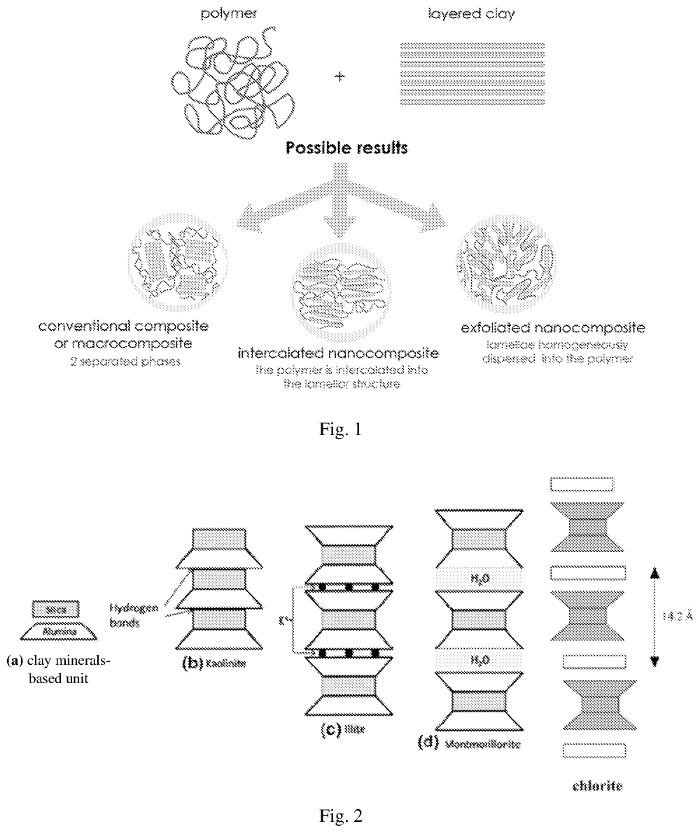

### DETAILED DESCRIPTION OF THE INVENTION

The invention relates, therefore, to a functionalized hybrid material comprising a raw material selected from clay, fruit waste, urban waste, fine ash, and combinations thereof, said raw material being functionalized with at least 15 wt % of at least one alkoxysilane cross-linking agent, based on the weight of the raw material.

It has, indeed, surprisingly been found that this functionalization allows to obtain a hybrid material which is advantageously able to absorb the hydrocarbon pollutants, as will also be seen in the working examples provided below.

In preferred embodiments, said at least one cross-linking agent and said raw material are in a weight ratio of 1:5 to 10:1.

More preferably, said at least one cross-linking agent and said raw material are in a weight ratio of 1:2 to 5:1.

Preferably, said raw material is clay.

Given their nano or micrometric structure, clays can be considered nanofillers. Owing to the presence of external —OH groups present on the planes of aluminosilicates, clays can be functionalized through grafting processes (grafting of molecules with specific chemical groups) to improve the chemical/physical characteristics thereof, such as lipophilia or hydrophilia, resistance to bacteria and chemical agents, heat resistance, etc. Clays constitute the most important class of common minerals which disperse in water in a colloidal form. They are mainly constituted of hydrated aluminium, silicon oxides and secondary minerals. They originate from erosion processes in primitive rocks.

Clayey minerals can reach a net negative charge following the replacement of Si (IV) and Al (III) ions with metal ions of a similar size but which are less charged. This negative charge must be compensated for by the coupling of cations with the surfaces of the layer of the clay. Since these cations do not have to adapt in specific sites in the crystalline network of the clays, these can be large ions, such as K+, Na+ or NH₄+. These cations are called exchangeable cations, because they can be replaced with other cations in water. The amount of exchangeable cations, expressed as milliequivalents of monovalent cations per 100 g dry clay, is called the cationic exchange capacity (or CEC) of the clay and it is a very important characteristic of the clay colloids.

Because of their structure and high surface area per unit of weight, clays have a strong tendency to absorb chemical species from water. Thus, clays play a role in the transportation and reaction of biological, chemical, organic, and gas wastes and other polluting species in water.

Some microbial processes occur on the surfaces of the particles of clay and, in some cases, the absorption of organic substances by the clay inhibits their biodegradation. Clay can therefore play a role in microbial degradation or in the degradation of organic wastes. The suspended particulate influences the mobility of the organic compounds absorbed by the particles. When the cationic organic compounds are absorbed by the clays, they are generally immobilized between the layers of the structure, in which their activity biologic is essentially zero.

The degree of absorption of the organic compounds is generally inversely proportional to their solubility in water. The absorption of neutral species such as oil, obviously, cannot be explained by the ionic exchange processes. It is probably a matter of chemical adsorption phenomena due to Van der Waals forces, hydrogenous bonds, complexations with charge transfers, and hydrophobic interactions.

It has been found that the two most important factors in estimating absorption of polar organic compounds are the organic carbon fraction (OCF) in solid adsorbents and the octanol/water partition coefficient (Kow) of the organic compound.

The different types of clayey minerals are formed from the combination of compound foils containing tetrahedral units (SiO₂) or octahedral units (Al₂O₃). Strong bonds of a covalent kind form the connection between the various base units, tetrahedral or octahedral unit, while weaker bonds and hydrogenous bonds mutually connect the elementary foils. The thickness of the crystals depends on the forces of attraction exerted mutually by the elementary packages. Since clayey minerals tend to develop preferentially flat networks, this force of attraction is somewhat low. Consequently, the crystals generally have a flattened form, with thicknesses variable ranging from a few tenths to a few hundredths of the average size on the plane of growth:
values of the specific weight of some minerals (g/cm³)

| | |
|---|---|
| Quartz | 2.65 |
| Feldspar-K | 2.54-2.57 |
| Feldspar-NA-Ca | 2.62-2.76 |
| Calcite | 2.72 |
| Dolomite | 2.85 |
| Kaolinite | 2.61-2.64 |
| Illite | 2.81 |
| Montmorillonite | 2.74 |
| Magnetite, Hematite | 4.9-5.1 |

approximate values of the specific surface area for some clayey minerals:

| | Average size | Specific surface area |
|---|---|---|
| | [mm] | [m²/g] |
| SANDS (sub-spherical form) | 2 mm | 2*10⁻⁴ |

CLAYEY MINERALS (lamellar form):

| | | |
|---|---|---|
| MONTMORILLONITE | 10⁻⁶ | up to 840 |
| ILLITE | (0.03 ÷ 0.1) × 10⁻³ | 654 ÷ 200 |
| KAOLINITE | (0.14 ÷ 4) × 10⁻³ | 104 ÷ 20 |

Various types of nanostructured clays are available on the market, among the main ones being, as stated above and as illustrated schematically in FIG. 2:
Kaolinite is constituted of tetrahedral units of silicon alternating with the aluminium octahedral units, which are mutually bonded very strongly. The thickness of the cluster is 7.5 Å. It is the most commonly found in nature, it is very stable and swells very little if exposed to water. Clusters thereof are mutually crosslinked and form extremely thick particles. It forms from the degradation in damp crystalline rock environments.
Illite is constituted of a layer of aluminium octahedrons comprised between two silicon tetrahedrons. Each cluster is crosslinked to another by means of a layer of potassium. The layer-to-layer-distance is 10 A. It has an irregular flake shape. Generally, it is more plastic than kaolinite. It does not expand if it comes into contact with water unless there is a potassium chain. It forms in marine environments from the degradation of micaceous rocks.
Montmorillonite: is constituted of a layer of aluminium octahedrons comprised between due silicon tetrahedrons. Each cluster is separate from the other by molecules of water and therefore the bonds between packages are very weak. Iron and magnesium can replace aluminium; aluminium can replace silicon. The layer-to-layer distance is 9.5 Å. The particles are flat and irregular in shape. Due to the weak bonds and the existence of a strong negative charge on the surface of the cluster, these minerals easily adsorb water showing a strong tendency to swell. It forms through decomposition of volcanic ashes, but also in zones with very hot climates and abundant rainfall.
Chlorite: is characterized by a layer of aluminium octahedrons comprised between two silicon octahedrons. The various clusters are mutually crosslinked by means of a layer of aluminium octahedrons. The layer-to-layer distance is 14 A. The particles are flat and irregular in shape. They tend not to swell. It forms in marine environments, but is not present in large amounts in nature.

The Plasticity Index, PI, is the amplitude of the range of water content within which the soil remains in a plastic state, i.e. the difference between the liquid limit (wL) and the plastic limit (wP, i.e. the water content at which the soil starts to lose its plastic behaviour):

PI (%)=wL−wP

This index depends on the percentage and the type of clay and the nature of the cations adsorbed. For each material, the plasticity index of grows linearly depending on the percentage of clay present, with a different gradient depending on the type of clayey minerals present:

| CLAYEY MINERALS | w_{L} (%) | wₚ (%) | Iₚ (%) |
|---|---|---|---|
| MONTMORILLONITE | 300-700 | 55-100 | 200-650 |
| ILLITE | 95-120 | 45-60 | 50-65 |
| KAOLINITE | 40-60 | 30-40 | 10-25 |

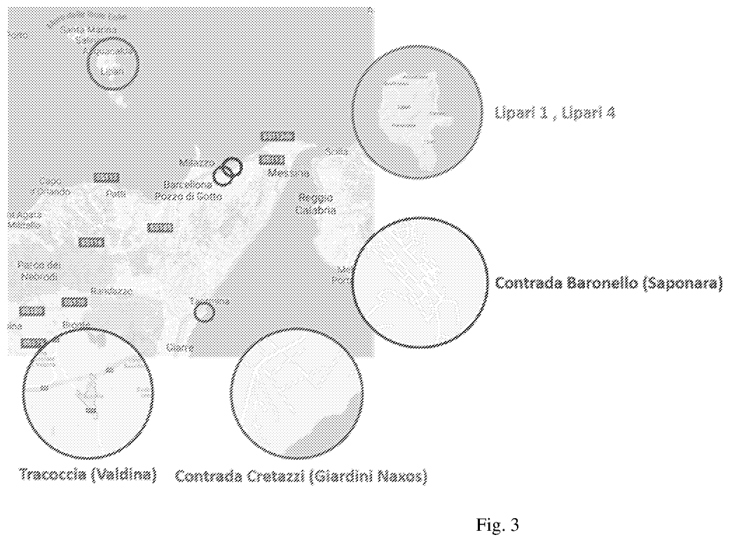

Preferred clays are Sicilian clays, in particular those named after the area where they are mined (FIG. 3), or labelled with codes: i) Lipari 1, ii) Lipari 4, iii) Tracoccia, iv) Baronello and v) Cretazzi.

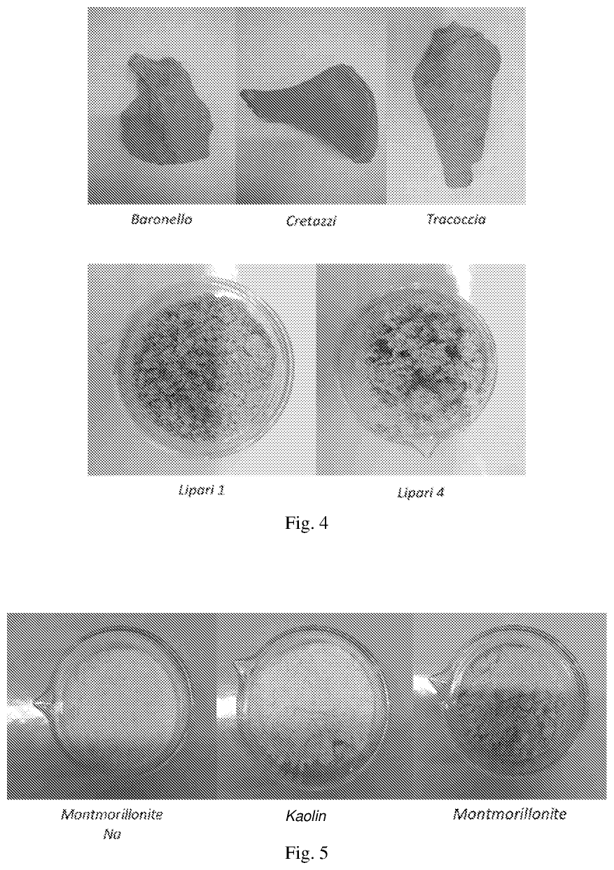

Clays labelled as Lipari 1 and Lipari 4 belong to the Montmorillonite class, while clays labelled Tracoccia, Baronello, and Cretazzi belong to the Illite class (FIG. 4).

Pure clays, meanwhile, are named according to the composition, or they are labelled as follows: i) Montmorillonite-Na (saturated with sodium atoms); ii) Montmorillonite (in which there is water between the layers) and iii) Kaolin (FIG. 5).

Alternatively, other natural clays can be employed, which are mined outside Sicily, such as clays belonging to the following classes: foils of phyllosilicate with six-membered rings, infinite two-dimensional foils of phyllosilicate with rings other than six-membered rings, tetrahedral foils condensed into phyllosilicates, modular layers of phyllosilicate, and combinations thereof.

A further application linked to the clays can be their use as geopolymers, inorganic polymers, similar to natural rocks, produced by geosynthesis and utilised to obtain ceramic materials. Geosynthesis consists of polymerization by condensation (geopolymerization) of base molecules originating from natural materials such as silica and alumina (in the case of clays) usually at temperatures of around 100° C. An important characteristic of geopolymers is that they do not contain water of hydration, and that they can be modified, for example by means of the addition of carbon to be rendered fire-resistant. The suitability of the use of geopolymers, as innovative materials in different fields of application, comes from their eco-sustainability since they are derived from recycled or easily sourced materials, from the properties thereof implemented and from their being innovative with respect to conventional materials, from the low energy requirements linked to their production and from the commercial and industrial sectors in which they can be put to use, such as the building industry, the restoration and recovery of cultural heritage, car manufacturing, metallurgy, the plastics industry etc.

### Functionalization of the Raw Material

For the purposes of the present invention, the raw material is functionalized so as to acquire specific characteristics, such as increased hydrophilia, in relation to the aqueous matrix (such as, in this case, sea water), or lipophilia, for greater oil absorption, with a reaction yield which is quantitatively equal to or greater than 95%. Depending on the silane utilised, it is possible to modify the final properties of the hybrid material to obtain, for example, materials which are also able to immobilize heavy metals.

In this sense, suitable silanes are:

(3-glycidyloxypropyl)trimethoxysilane (GPTMS), hexadecyltrimethoxysilane (C16), diethoxy(3-glycidyloxypropyl)methylsilane, triethoxy(ethyl)silane, triacetoxy(methyl)-silane, tris(2-methoxyethoxy)(vinyl)silane, mpeg20k-silane, mpeg5k-silane, trichloro(phenyl)silane, trichloro(hexyl)silane, triethoxy(octyl)silane, trichloro-(phenethyl)silane, trimethoxy[2-(7-oxabicyclo[4.1.0]hept-3-yl)ethyl]silane, trichloro-(dichloromethyl)silane, silane A 174, triacetoxy(vinyl)silane, triethyl(silane-d), diphenyl(silane-d2), trimethoxy(propyl)silane, tris(trimethylsilyl)silane, trichloro-(octadecyl)silane, trimethoxy(octyl)silane, trimethoxy(octadecyl)silane, isobutyl-(trimethoxy)silane, triethyl(trifluoromethyl)silane, chloromethyl(dimethyl)silane, trichloro(octyl)silane, trimethyl(phenyl)silane, trimethyl(propargyl)silane, trimethyl-(trifluoromethyl)silane, tetrakis(trimethylsilyl)silane, tris(dimethylamino)silane, trimethyl(tributylstannyl)silane, trimethyl[(tributylstannyl)ethynyl]silane, tris(trimethyl-siloxy)silane, tert-butyldimethyl(2-propynyloxy)silane, trimethoxy(7-octen-1-yl)silane, chlorotris(trimethylsilyl)silane, (3-aminopropyl)tris(trimethylsiloxy)silane, trimethoxy-[3-(methylamino)propyl]silane, trichloro(3,3,3-trifluoropropyl)silane, trimethoxy(3,3,3-trifluoropropyl)silane, trimethyl(trifluoromethyl)silane solution, (3-mercaptopropyl)-trimethoxy-d9-silane, chloro-dimethyl(3,3,3-trifluoropropyl)silane, (3-chloropropyl)-tris(trimethylsiloxy)silane, chlorodimethyl(pentafluorophenyl)silane, butyldimethyl-(dimethylamino)silane, trimethoxy(2-phenylethyl)silane, trimethyl(phenylthio)silane, dimethoxy-methyl(3,3,3-trifluoropropyl)silane, tetrakis(trimethylsilyloxy)silane, tris(trimethylsiloxy)(vinyl)silane, trimethyl(phenoxy)silane, trimethyl(propoxy)silane, diisopropyl(3,3,4,4,5,5,6,6,7,7,8,8,9,9,10,10,10-heptadecafluorodecyl)silane, triethoxy-(1-phenylethenyl)silane, trichloro[2-(chloromethyl)allyl]silane, trimethyl(2,3,4,5-tetramethyl-2,4-cyclopentadien-1-yl)silane, trimethyl(methylthio)silane, chlorodi-methyl(2,3,4,5-tetramethyl-2,4-cyclopentadien-1-yl)silane, chlorotris(triethylsilyl)-silane, trimethyl(phenylthiomethyl)silane, chlorotris(trimethylsilyl)silane solution, methyltris(tri-sec-butoxysilyloxy)silane, tris(triethylsilyl)silane, (chloromethyl)methyl-bis(pentafluorophenyl)silane, 3-methacrylamidopropyltris(trimethylsiloxy)silane, diisopropyl(3,3,4,4,5,5,6,6,6-nonafluorohexyl)silane, dimethyl-di(methacroyloxy-1-ethoxy)silane, isopropoxy(phenyl)silane, trichloro(1h,1h,2h,2h-perfluorooctyl)silane, chlorotrimethylsilane, dichlorodimethylsilane, vinyltrimethoxysilane, chlorotriethyl-silane, methyltrichlorosilane, 3-(trimethoxysilyl)propylmethacrylate, chloro-dimethyl-octadecylsilane solution, dichloro-methyl-octadecylsilane, dichloro(chloromethyl)-methylsilane, cyanomethyl [3-(trimethoxysilyl)propyl] trithiocarbonate, 3-(triethoxysilyl)propylisocyanate, vinyltrimethylsilane, tetraallylsilane, isobutyltriethoxysilane, tris(dimethylsiloxy)phenylsilane, 1-phenyl-2-trimethylsilyl-acetylene, 3-trimethylsiloxy-1-propyne, chlorodimethylphenethylsilane, 2-(allyldimethylsilyl)pyridine, 3-[tris(trimethylsiloxy)silyl]propylmethacrylate, n-[3-(trimethoxysilyl)propyl]aniline, tetramethyl-d12 orthosilicate, 3-cyanopropyl-trichlorosilane, 2-(dimethylsilyl)pyridine, (2-thienyl)trimethylsilane, 5-(tert-butyldimethylsilyloxy)-1-pentyne, allyl(4-methoxyphenyl)dimethylsilane, n-octadecyltriethoxysilane, chloro(dimethyl) thexylsilane, 1h,1h,2h,2h-perfluoro-octyltriethoxysilane, silicon 2,3-naphthalocyanine bis(trihexylsilyloxide), 1-(1-naphthyl)-2-(trimethylsilyl)acetylene, 2-tert-butyldimethylsiloxybut-3-yne, (e)-3-(tert-butyldimethylsilyloxy)propene-1-yl-boronic acid pinacolester, (3-phenylpropyl)silane, (1-bromo-2,2-diphenylcyclopropyl) (trimethyl)silane, (1-hydroxy-allyl)-tri-methyl-silane, (2,2-dibromocyclopropyl)(trimethyl)silane, (2-biphenylyl)tris(decyl)silane, (2-isopropyl-1-cyclopropen-1-yl) (triphenyl)silane, (2-methyl-1-cyclopropen-1-yl)(triphenyl)silane, (2-methyl-allyl)-triphenyl-silane, (3-biphenylyl)tris(3-phenyl-propyl)silane, (3-methyl-3-butenyl)(triphenyl)silane, (4-bromobutoxy)(trimethyl)silane, (4-chlorobenzoyl)(triphenyl)silane, (4-fluorobenzoyl)(triphenyl)silane, (4-iodo-1-butynyl)(trimethyl)silane, (4-methoxy-1-cyclohexen-1-yl)(trimethyl)silane, {[(4-methoxybenzyl)oxy]methyl}(trimethyl)silane, {[(4-methoxybenzyl)oxy]methyl}-(trimethyl)silane, [(4-methoxyphenoxy)methyl](trimethyl)silane, (4-methoxyphenyl)-tri(o-tolyl)silane, (4-methoxyphenyl)tris(4-(dimethylamino)phenyl)silane, (4-nitrobenzoyl)(triphenyl)silane, (4-phenoxyphenyl)(phenyl)(o-tolyl)silane, (4-tert-butyl-1-cyclohexen-1-yl)(trimethyl)silane, (4-tert-butylbenzoyl)(triphenyl)silane, (4-tert-butylcyclohexyl)(trimethyl)silane, (4-tert-butylphenyl)diphenyl(o-tolyl)silane, (5,5-dimethyl-1-cyclopenten-1-yl)(trimethyl)silane, (5-iodo-1-pentynyl)(trimethyl)silane, (6,6-dimethyl-1-cyclohexen-1-yl)(trimethyl)silane, (7-bromo-2-naphthyl)(trimethyl)-silane, (9,10-dihydro-9-anthracenyl)trimethyl-silane, (chloromethyl)dimethyl-(pentafluorophenyl)silane, (o-tolyloxy)tri(o-tolyl)silane, (p-tolyl)tris(1-naphthyl)silane, 1,3-diphenyl-1-propenyloxy(dimethyl)(pentafluorophenyl)silane, 1,3-diphenyl-1-propenyloxy(dimethyl)(trimethylsilylmethyl)silane, [1-(1-chloro-2-cyclopropylidene-ethyl)cyclopropyl](trimethyl)silane, [1-(1-cyclohexen-1-yl)cyclopropyl](trimethyl)-silane, [1-(bromomethyl)cyclopropyl](trimethyl)silane, [1-(cyclohexylidenemethyl)-cyclopropyl](trimethyl)silane, [1-(cyclopentylidenemethyl)cyclopropyl](trimethyl)-silane, [1-(dimethoxymethyl)cyclopropyl](trimethyl)silane, 1-cyclododecen-1-yl(trimethyl)silane, 1-cyclohepten-1-yl(trimethyl)silane, 1-cyclopenten-1-yl(trimethyl)-silane, [2-(cyclohexylmethyl)-2-propenyl](trimethyl)silane, [2-chloro-2-(phenylsulfonyl)ethyl](trimethyl)silane, 2-cyclohexen-1-yl(trimethyl)silane, 2-cycloocten-1-yl(trimethyl)silane, allyl(methyl) 1-naphthyl(phenyl)silane, benzoyl(tris(4-tert-butylphenyl))silane, benzyl(3-phenylpropyl)silane, benzyltris(3-phenylpropyl)-silane, benzyltris(p-terphenylyl)silane, bis(2-chlorobenzyl)silane, bis(3-phenylpropyl)-silane, butyldimethyl(2,3,4,5-tetrafluorophenyl)silane, butyldimethyl(2,3,5,6-tetrafluoro-phenyl)silane, butyldimethyl(pentafluorophenyl)silane, chlorodiphenyl(diphenyl-methyl)silane, chloromethyl-triethyl-silane, chloromethyldimethyl(pentachloro-phenyl)silane, chlorotri(2-biphenylyl)silane, chlorotri(o-tolyl)silane, chlorotris(1-naphthyl)silane, chlorotris(2-methoxyphenyl)silane, dibenzyldi(m-tolyl)silane, dicyclohexyl-methyl-silane, dimethyl(2,3,5,6-tetrafluorophenyl)silane, dimethyl(2,3,6-trichlorophenyl)silane, dimethyl(2,4,6-trichlorophenyl)silane, dimethyl(3,4,5-trichloro-2-thienyl)silane, dimethyl(3-(pentachlorophenyl)propyl)(pentafluorophenyl)silane, dimethyl(3-phenylpropyl)silane, dimethyl(diphenylmethoxy)(pentafluorophenyl)silane, dimethyl(pentachlorophenyl)silane, dimethyl(pentafluorophenyl)(3-(pentafluoro-phenyl)propyl)silane, diphenyl(1-naphthyl)silane, diphenyl(3-phenylpropyl)silane, diphenyl(4-methoxyphenyl)silane, diphenyl(4-phenoxyphenyl)silane, diphenyl(9-fluorenyl)silane, diphenyl(diphenylmethoxy)(diphenylmethyl)silane, diphenyl(diphenyl-methyl)silane, diphenyl(m-tolyl)silane, diphenyl(o-tolyl)(4-trimethylsilyl)phenyl)silane, diphenyl(p-tolyl)silane, diphenyl(pentachlorophenyl)silane, diphenyldi(m-tolyl)silane, diphenyldi(o-tolyl)silane, diphenylmethyl(o-tolyl)silane, diphenylmethyl(pentachloro-phenyl)silane, diphenylmethyl(pentafluorophenyl)silane, diphenylphenethyl(o-tolyl)silane, dodecyltris(2-biphenylyl)silane, dodecyltris(2-cyclohexylethyl)silane, dodecyltris(3-chlorophenyl)silane, dodecyltris(3-fluorophenyl)silane, dodecyltris(m-tolyl)silane, ethoxytri(o-tolyl)silane, ethoxytris(2-methoxyphenyl)silane, ethyl-bis-(2,4,6-trimethyl-phenyl)-silane, ethylenebis(tris(decyl)silane), hexadecyl-sulfanylethynyl-trimethyl-silane, hexadecyltris(3-chlorophenyl)silane, hexadecyltris(3-fluorobenzyl)silane, hexadecyltris(3-phenylpropyl)silane, hexadecyltris(4-chloro-phenyl)silane, methylphenyl(4-(trimethylsilylmethyl)phenyl)silane, methylphenyl(m-tolyl)silane, methyltris(2-methoxyethoxy)silane, methyltris(3,4,5-trichloro-2-thienyl)silane, methyltris(p-terphenyl-4-yl)silane, methyltris(pentafluorophenyl)silane, octadecyltris(2-biphenylyl)silane, octadecyltris(2-cyclohexylethyl)silane, octadecyltris-(3-chlorophenyl)silane, octadecyltris(3-fluorophenyl)silane, octadecyltris(4-chloro-phenyl)silane, phenyl(o-tolyl)silane, phenyltri(m-tolyl)silane, phenyltri(o-tolyl)silane, phenyltri(p-tolyl)silane, phenyltris(2-cyclohexylethyl)silane, phenyltris(2-ethyl-hexyl)silane, phenyltris(3-fluorophenyl)silane, phenyltris(3-phenylpropyl)silane, phenyltris(4-(trimethylsilyl)phenyl)silane, phenyltris(4-fluorobenzyl)silane, phenyltris(9-ethyl-3-carbazolyl)silane, phenyltris(9-fluorenyl)silane, phenyltris(p-terphenylyl)silane, tert-butyl(dimethyl)[(2e)-2,4-pentadienyloxy]silane, tetra(phen-ethyl)silane, tetrakis((p-tolyl)thiomethyl)silane, tetrakis((trimethylsilyl)methyl)silane, tetrakis(2-cyclohexylethyl)silane, tetrakis(2-ethylhexyl)silane, tetrakis(2-methoxyphenyl)silane, tetrakis(2-naphthyl)silane, tetrakis(3,4,5-trichloro-2-thienyl)-silane, tetrakis(3-(trifluoromethyl)phenyl)silane, tetrakis(3-chlorophenyl)silane, tetrakis(3-fluorophenyl)silane, tetrakis(3-phenylpropyl)silane, tetrakis(4-(dimethyl-amino)phenyl)silane, tetrakis(4-(trimethylsilyl)phenyl)silane, tetrakis(4-biphenylyl)-silane, tetrakis(dimethylphenylsilyl)silane, tetrakis(p-tolyl)silane, tetrakis(pentafluoro-phenyl)silane, tetrakis(phenylthiomethyl)silane,tetrakis(triphenylstannyl)silane, trans-styryltris(pentafluorophenyl)silane, tri(o-tolyl)silane, triethyl(triphenylgermyl)silane, trihexadecyl(4-(trimethylsilyl)phenyl)silane, trimethyl[(1z)-1-propyl-1-butenyl]silane, trimethyl[(2e)-3-phenyl-2-propenyl]silane, trimethyl[1-(trimethylsilyl)vinyl]silane, trimethyl[2-[(trimethylsilyl)methyl]-2-propenyl]silane, trimethyl[2-(1-phenylvinyl)-cyclopropyl]silane, trimethyl[6-(trimethylsilyl)-1,5-hexadiynyl]silane, trimethyl(1-methyl-1,2-diphenylethyl)silane, trimethyl(1-naphthylmethyl)silane, trimethyl(1-phenyl-2-propenyl)silane, trimethyl(3-phenyl-2-cyclohexen-1-yl)silane, trimethyl(4-(trimethylsilyl)butoxy)silane, trimethyl(4-methyl-1,5-cyclohexadien-1-yl)silane, trimethyl(4-methyl-3-penten-1-ynyl)silane, trimethyl(5-methyl-1,5-cyclohexadien-1-yl)silane, trimethyl(6-methyl-1-cyclohexen-1-yl)silane, trimethyl(6-phenyl-1-cyclo-hexen-1-yl)silane, trimethyl(pentafluorophenyl)silane, trimethyl-(1-methyl-1-phenyl-propoxy)silane, trimethyl-(4-nitro-phenylethynyl)-silane, triphenyl(1,2,2-triphenyl-ethyl)silane, triphenyl(3-(triphenylgermyl)propyl)silane, triphenyl(triphenylmethyl)-silane, triphenyl(undecyl)silane, tris(1-naphthyl)silane, tris(2-biphenyl)silane, tris(2-chlorobenzyl)silane, tris(3,4,5-trichloro-2-thienyl)silane, tris(3-biphenylyl)silane, tris(4-(trimethylsilyl)phenyl)silane, tris(4-bromophenyl)silane, tris(decyl)silane, tris(hexadecyl)silane, tris(pentachlorophenyl)silane, tris(pentafluorophenyl)silane, tris(phenethyl)silane, ([4,4-dimethyl-3-[2-(2-methyl-1,3-dioxolan-2-yl)ethyl]-1-cyclo-penten-1-yl]oxy)(trimethyl)silane, ((1e)-3-[[tert-butyl(dimethyl)silyl]oxy]-1-propenyl)-(trimethyl)silane, {[(1r,2s,5r)-2-isopropyl-5-methylcyclohexyl]oxy}(methyl)1-naphthyl-(phenyl)silane, {[(1r,2s,5r)-2-isopropyl-5-methylcyclohexyl]oxy}(trimethyl)silane, {[(1s)-1-isopropyl-5,5-dimethyltricyclo[4.1.0.0(2,4)]hept-4-yl]oxy}(trimethyl)silane, [(1z)-1-ethyl-1-propenyl](methyl)1-naphthyl(phenyl)silane, (2-{[(3-bromo-2-cyclo-hexen-1-yl)oxy]methoxy}ethyl)(trimethyl)silane, [(2-isopropyl-5-methylcyclohexyl)-oxy](methyl)1-naphthyl(phenyl)silane, [[(2s)-3-chloro-3,7,7-trimethyltricyclo-[4.1.1.0(2,4)]oct-2-yl]oxy](trimethyl)silane, (4,4-dimethyl-1,5-cyclohexadien-1-yl)-(methyl)1-naphthyl(phenyl)silane, [(4s,5r)-5-ethyl-4-methyl-1-cyclopenten-1-yl](trimethyl)silane, (6-isopropyl-3-methyl-1-cyclohexen-1-yl)(trimethyl)silane, [1-[(1z)-1-ethyl-1-propenyl]cyclopropyl](trimethyl)silane, [1-[(2,6-dimethyl-2-cyclohexen-1-ylidene)methyl]cyclopropyl](trimethyl)silane, [1-[(7,9-dimethyl-1,4-dioxaspiro-[4.5]dec-8-ylidene)methyl]cyclopropyl](trimethyl)silane, [1-[bis(phenylsulfanyl)-methyl]cyclopropyl](trimethyl)silane, 1-cyclohexen-1-yl(methyl)1-naphthyl(phenyl)-silane, 1-cycloocten-1-yl(methyl)1-naphthyl(phenyl)silane, 1-oxaspiro[2.2]pent-4-yl(triphenyl)silane, [2,2-dimethyl-3-(tetrahydro-2h-pyran-2-yloxy)propoxy](trimethyl)-silane, [2-({[(2e,6s)-2,6-dimethyl-7-(2-oxiranyl)-2-heptenyl]oxy}methoxy)ethyl]-(trimethyl)silane, [2-([[tert-butyl(dimethyl)silyl]oxy]methyl)-2-propenyl](trimethyl)-silane, [3,7-dimethoxy-6-(trimethylsilyl)dibenzo[b,d]furan-4-yl](trimethyl)silane, [3-([[tert-butyl(dimethyl)silyl]oxy]methyl)-2,2-dichlorocyclopropyl](trimethyl)silane, 6,9-dihydro-5h-benzo[a]cyclohepten-7-yl(trimethyl)silane, bicyclo[2.2.2]oct-2-yl(tri-methyl)silane, bicyclo[3.1.0]hex-6-yl(trimethyl)silane, bicyclo[3.2.1]oct-2-en-3-yl-(trimethyl)silane, bicyclo[4.1.0]hept-2-en-7-yl(trimethyl)silane, bis(pentafluorophenyl)-methyl(alpha-styryl)silane, dimethylphenyl(phenyl(2,3,5,6-tetrachloro-4-pyridyl)-methoxy)silane, methyl(4-methyl-1-cyclohexen-1-yl)1-naphthyl(phenyl)silane, tert-butyl(dimethyl) [(1,7,7-trimethylbicyclo[2.2.1]hept-2-en-2-yl)oxy]silane, tert-butyl-(dimethyl)[[(2r)-2-methyl-3-(phenylsulfonyl)propyl]oxy]silane, tert-butyl(dimethyl)-[(3,3,9,9-tetrachlorotricyclo[6.1.0.0(2,4)]non-6-yl)oxy]silane, tert-butyl(dimethyl)[(4-methyl-4-pentenyl)oxy]silane, tert-butyl(dimethyl) [(5s)-tricyclo[6.1.0.0(2,4)]non-6-en-5-yloxy]silane, tert-butyl(dimethyl){2-methyl-2-[(2s)-2-oxiranyl]propoxy}silane, tert-butyl(dimethyl) {[3-(trimethylstannyl)-3-butenyl]oxy}silane, tert-butyl(dimethyl)[[4-(tributylstannyl)-3-furyl]methoxy]silane, tert-butyl(dimethyl)(tetracyclo-[7.1.0.0(2,4).0(5,7)]dec-8-yloxy)silane, tert-butyl(diphenyl)(2,3,5,6-tetrabromo-4-{[tert-butyl(diphenyl)silyl]oxy}phenoxy)silane, tert-butyl-(2,2-dimethyl-(1,3)dioxolan-4-ylmethoxy)-diphenyl-silane, trimethyl[(1e)-1-methyl-3-(triphenylstannyl)-1-propenyl]-silane, trimethyl{(3s)-4-methyl-2-(phenylsulfonyl)-3-[(phenylsulfonyl)methyl]pentyl}-silane, trimethyl[(4-methyl-3-cyclohexen-1-yl)methyl]silane, trimethyl[1-[(2-methyl-2-cyclohexen-1-ylidene)methyl]cyclopropyl]silane, trimethyl[1-(7-oxabicyclo-[4.1.0]hept-1-yl)cyclopropyl]silane, trimethyl[2-[8-(phenylsulfonyl)-1,4-dioxaspiro-[4.5]dec-8-en-7-yl]ethyl]silane, trimethyl[2-({[(2s)-2-methyl-3-butynyl]oxy}methoxy)ethyl]silane, trimethyl(13-oxabicyclo[10.1.0]tridec-1-yl)silane, trimethyl(2-phenyl-1,1-bis(trimethyl-silyl)ethyl)silane, trimethyl(6-phenyl-7-oxabicyclo[4.1.0]hept-2-yl)silane, trimethyl(7-oxabicyclo[4.1.0]hept-1-yl)silane, trimethyl(spiro[4.5]dec-6-en-6-yl)silane, trimethyl-(tricyclo[4.1.0.0(2,7)]hept-1-yl)silane, trimethyl-(4′-naphthalen-1-yl-biphenyl-4-yl)-silane, ({2-[2-(methoxymethoxy)ethyl]-5,5-bis [(3e)-5-(phenylsulfanyl)-3-pentenyl]-1-cyclopenten-1-yl}oxy)(trimethyl)silane, ({4-[1-({[tert-butyl(dimethyl)silyl]oxy}-methyl)-2-methylpropyl]-2-methyl-1,5-cyclohexadien-1-yl}oxy)(trimethyl)silane, {[(1ar,3r,11as,11br)-3-methoxy-1,1-dimethyl-1a,2,3,5,6,7,10,11,11a,11b-decahydro-1h-cyclopropa[3,4]benzo[1,2-a]cyclodecen-9-yl]oxy}(trimethyl)silane, [[(1r,2ar,4ar,6as,6br)-1-vinyl-1,2,2a,4a,6a,6b-hexahydrocyclopenta [cd]pentalen-1-yl]oxy](trimethyl)-silane, (2,6-ditert-bu-4(3,5-ditert-bu-4((tri-me-silyl)oxy)benzyl)phenoxy)(tri-me)silane, (2-{[((2s,4as,5s,7s,7ar)-5-ethoxy-7-(iodomethyl)-2-(4-methoxyphenyl)dihydro-4h-furo[3,4-d][1,3]dioxin-4a(5h)-yl)oxy]methoxy ethyl)(trimethyl)silane, (2-{[((2s,4as,7s,7ar)-5-ethoxy-7-(iodomethyl)-2-(4-methoxyphenyl)dihydro-4h-furo[3,4-d][1,3]-dioxin-4a(5h)-yl)oxy]methoxy}ethyl)(trimethyl)silane, [[(4s,4ar,5r,6s,8ar)-4-(3-butenyl)-3,4a,6-trimethyl-5-(3-methyl-3-butenyl)-1,4,4a,5,6,7,8,8a-octahydro-2-naphthalenyl]oxy](trimethyl)silane, {2,6-ditert-butyl-4-[3,5-ditert-butyl-4-[(trimethylsilyl)oxy]phenyl}(ethoxy)methyl]phenoxy}(trimethyl)silane, [2-[([(1 s,3as,7ar)-3a-[(2-methoxyethoxy)methoxy]-7a-methyl-2,3,3a,6,7,7a-hexahydro-1h-inden-1-yl]oxy)methoxy]ethyl](trimethyl)silane, [2-({[(1r,3r,6s)-7,7-dimethyl-4-methylenebicyclo[4.1.0]hept-3-yl]oxy}methoxy)ethyl](trimethyl)silane, [2-({[(1s,6r)-3-bromo-7-oxabicyclo[4.2.0]oct-2-en-1-yl]oxy methoxy)ethyl](trimethyl)silane, [2-({[(2e,6s)-7-(1,3-dithian-2-yl)-2,6-dimethyl-2-heptenyl]oxy}methoxy)ethyl](trimethyl)silane, [2-({[(2e,6s)-9-iodo-2,6-dimethyl-8-(tetrahydro-2h-pyran-2-yloxy)-2-nonenyl]oxy}-methoxy)ethyl](trimethyl)silane, tert-butyl(dimethyl)[[(2s,4s)-4-(2-phenylethyl)-3,4-dihydro-2h-pyran-2-yl]methoxy]silane, triethyl[((4z)-5-(2s,3r)-2-methoxy-3-[(4-methoxybenzyl)oxy]-7,7-dimethyl-1-vinylbicyclo[2.2.1]hept-2-yl}-3-methylene-4-pentenyl)oxy]silane, trimethyl[[(1 s,5r,6r,7r)-7-methyl-7-vinylbicyclo[3.2.0]hept-2-en-6-yl]oxy]silane, trimethyl[1-methyl-2-({1-[7-(1-{1-methyl-2-[(trimethylsilyl)oxy]-propoxy}vinyl)-2-naphthyl]vinyl}oxy)propoxy]silane, trimethyl({(4s)-4-methyl-3-[2-(2-methyl-1,3-dioxolan-2-yl)ethyl]-1-cyclopenten-1-yl}oxy)silane, ({(1bs,4ar,7ar,7br,8r)-1,1,8-trimethyl-7b-[(trimethylsilyl)oxy]-1a,1b,2,4a,5,6,7,7a,7b,8,9,9a-dodeca-hydro-1h-cyclopropa[3,4]benzo[1,2-e]azulen-4-yl}oxy)(trimethyl)silane, [(2r,3s,4r,5r,6s)-2-(iodomethyl)-6-{[(2r,3s,4s,5r,6s)-6-(iodomethyl)-3,4,5-tris(trimethylsilyl)-tetrahydro-2h-pyran-2-yl]oxy}-4,5-bis(trimethylsilyl)tetrahydro-2h-pyran-3-yl](trimethyl)silane, {2-[({(3ar,5s,5ar,6s,9s,9br)-9-{[tert-butyl(dimethyl)silyl]oxy}-9b-[3-(methoxymethoxy)propyl]-2,3,3,5a-tetramethyl-5-[(triethylsilyl)oxy]-3a,4,5,5a,6,7,8,9,9a,9b-decahydro-3h-cyclopenta[a]naphthalen-6-yl}oxy)methoxy]-ethyl}(trimethyl)silane, 2,4,6,8-tetramethylcyclotetrasiloxane, ethynyltrimethylsilane, triethoxymethylsilane, trimethoxymethylsilane, triethoxyvinylsilane, hexachlorodisilane, dimethoxydimethylsilane, methoxytrimethylsilane, diethoxydimethylsilane, trichlorovinylsilane, methyldiethoxysilane, bis(trimethylsilyl)acetylene, ethoxytrimethylsilane, dimethoxymethylvinylsilane, tert-butyltrichlorosilane, (chloromethyl)triethoxysilane, trans-1-methoxy-3-trimethylsiloxy-1,3-butadiene, 1,2-bis(triethoxysilyl)ethane, 1,2-bis(trimethoxysilyl)ethane, 1,2-bis(trichlorosilyl)ethane, 1,3-diethoxy-1,1,3,3-tetramethyldisiloxane, (3-aminopropyl)triethoxysilane, (triiso-propylsilyl)acetylene, tetraethylorthosilicate, diethoxy(3-glycidyloxypropyl)-methylsilane, (3-mercaptopropyl)trimethoxysilane, triethoxysilane, tetramethylsilane, phenylsilane, hexamethyldisiloxane, diphenylsilane, bromotrimethylsilane, tetramethylorthosilicate, triphenylsilane, diphenylsilanediol, dichlorodiphenylsilane, chlorotriphenylsilane, triphenylsilanol, allyltrichlorosilane, triethoxyphenylsilane, trihexylsilane, benzyldimethylsilane, tetravinylsilane, chlorotributylsilane, trichlorododecylsilane, chlorotrihexylsilane, hexamethyldisiloxane solution, chlorotrimethylsilane solution, dichlorophenylsilane, tributylchlorosilane, dodecyltriethoxysilane, diethoxydiphenylsilane, hexylsilane, trioctylsilane, chlorotripropylsilane, (3-chloropropyl)triethoxysilane, 3-(triethoxysilyl)propionitrile, (chloromethyl)dimethylphenylsilane, (3-chloropropyl)trichlorosilane, trichloromethyl-silane, bis(dimethylamino)dimethylsilane, 3-(2-aminoethylamino)propyldimethoxy-methylsilane, trichlorocyclopentylsilane, (3-aminopropyl)trimethoxysilane, (2-bromoethoxy)-tert-butyldimethylsilane, methoxy(dimethyl)octylsilane, tert-butyldimethylsilylglycidylether, (3-bromopropyl)trimethoxysilane, methoxy(dimethyl)-octadecylsilane, dimethyloctadecyl[3-(trimethoxysilyl)propyl]ammoniumchloride solution, tetrafluoro-2-(tetrafluoro-2-iodoethoxy)ethanesulfonylfluoride, [3-(2-aminoethylamino)propyl]trimethoxysilane, (3-glycidyloxypropyl)triethoxysilane, (3-bromopropoxy)-tert-butyldimethylsilane.

The sol-gel technique is a very simple synthetic method which allows the formation of an inorganic/organic siliceous-based network. The network is formed through hydrolysis and condensation of a metal-organic precursor, such as an alkoxide M(OR)ₙ. The organic molecules can be incorporated into this solid matrix, giving rise to a functionalized sol with high thermal and mechanic stability.

In this sense, the trialkoxysilanes are preferably functional molecules which can be utilised as cross-linking reagents for the functionalization of appropriate nanofillers and the dispersion thereof inside a sol-gel-based hybrid polymeric matrix, allowing the formation of a nanohybrid material or of a functional nanocomposite, is also utilizable for coating surfaces. Functionalizable surfaces can include the textile fibres which, after the application of functional coatings, can be used to create technical, innovative, or smart fabrics. Indeed, natural plant fibres, such as cotton, are mainly compounds of cellulose, a natural polymer which has as its structural unit glucose joined with β-glycosidic bonds and features external —OH groups. These functional groups lend themselves well to the grafting processes which allow the inclusion—therewithin or on the surface of fabric—of a different type of nanostructure, to introduce a new functions or implement the physical/mechanical properties of cotton fibres.

Preferred trialkoxysilanes are those comprising at least one epoxydic group, also known as epoxydic trialkoxysilanes, which lend the clays specific characteristics such as increased hydrophilia, in relation to the aqueous matrix (such as, on this case, sea the water). Preferably then, said at least one cross-linking agent is an epoxydic trialkoxysilane.

Among the suitable epoxydic trialkoxysilanes, 3-glycidoxypropyltrimethoxysilane (GPTMS) is particularly preferred.

In order to create the sol-gel matrices, wherein including the nanofillers of organic or inorganic origin, which were then also applied to the fabrics, so as to implement the physical/chemical properties and the mechanical characteristics of the clays and of the fabric fibres, it was decided to modify a sol-gel synthesis approach, based on GPTMS:

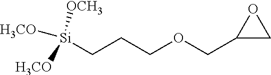

The 3-glycidoxypropyltrimethoxysilane or GPTMS acts as a linker between the fabric and said nanofiller. Indeed, owing to its bifunctionality, through the trimethoxysilane end, the GPTMS allows the formation of a sol-gel network or anchorage to the clay or to the fabric, through condensation with the —OH groups, and release of MeOH, while—by means of the epoxydic ring (following a nucleophile coupling with consequent opening of said ring)—it produces the formation of a heterolytic covalent bond in the presence of a nucleophile:

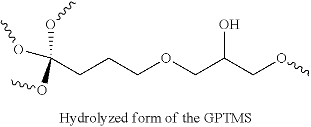

The synthesis of hybrid materials based on the GPTMS epoxydic molecule is therefore a process involving multiple steps, comprising the formation of a siliceous-based network and the functionalization of the epoxide, with the opening of said epoxydic ring.

When instead it is desirable to increase the lipophilia of the clay and consequently the affinity for oil of the end hybrid material, then long-chain aliphatic trialkoxysilanes are preferred. Preferably then, said at least one cross-linking agent is aliphatic trialkoxysilane having the following formula (I):

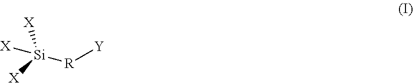

where X is an alkoxy group, and R is a C4-C20 aliphatic chain, and Y is methyl, an amine group or a thiol group.

Among the long-chain aliphatic trialkoxysilanes, hexadecyltrimethoxysilane (C16) is particularly preferred as it features both a trimethoxysilane group which can be coordinated with the clay and a long hydrocarbon tail:

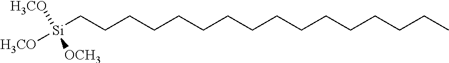

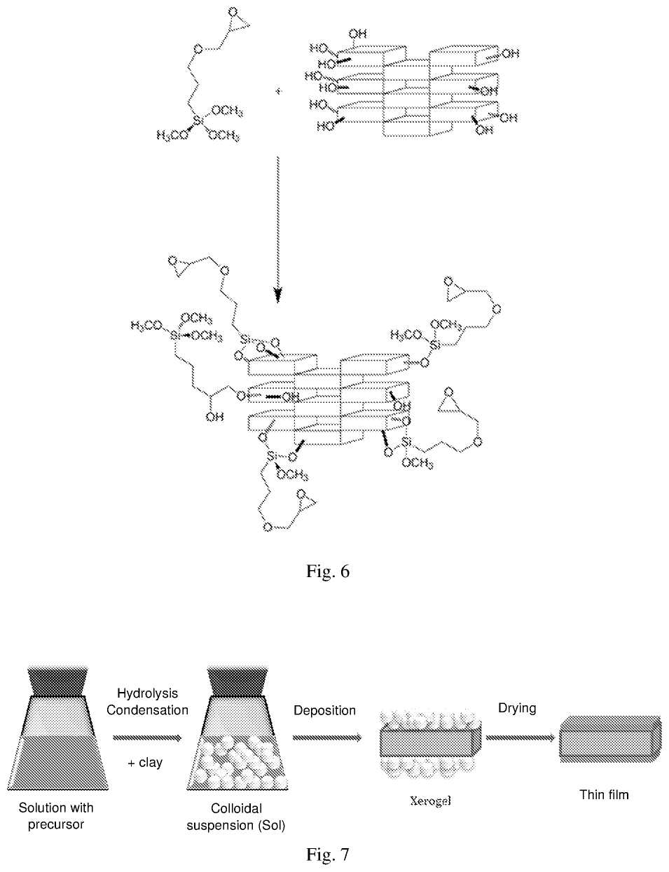

The functionalization (FIG. 6) was performed on the powders of dispersed and desiccated clays by additions of silanes in a total ratio preferably amounting to three times the weight of the clay.

In preferred embodiments, the functionalized hybrid material comprises raw material functionalized with a mixture of a) at least one epoxydic trialkoxysilane and b) at least one aliphatic trialkoxysilane having formula (I).

In particularly preferred embodiments, the functionalized hybrid material comprises clay functionalized with a mixture of a) at least one trialkoxysilane epoxydic and b) at least one aliphatic trialkoxysilane having formula (I), wherein a) and b) are in a weight ratio of 5:1 to 1:5.

More preferable are the embodiments wherein the functionalized hybrid material comprises clay functionalized with a mixture of GPTMS and C16, wherein GPTMS and C16 are in a weight ratio of 2:1 to 1:2. Preferably, said mixture and said clay are in a weight ratio of 1:5 to 10:1, more preferably 1:2 to 5:1. In particularly preferred embodiments, said mixture and said clay are in a weight ratio of about 3:1.

In another aspect, the present invention concerns a process for the preparation of the functionalized hybrid material comprising the following steps:

1) supplying the raw material,

2) adding the alkoxysilane cross-linking agent,

3) adding an organic solvent, and preferably adjusting the pH to basic,

4) leaving to react under stirring for at least 6 hours,

5) separating the raw material thus functionalized, and

6) desiccating, thus obtaining the functionalized hybrid material.

In preferred embodiments, the pH is adjusted by adding NaOH or KOH.

Preferably, the sol-gel reactions were carried out using the GPTMS and a mixture 1:1 GPTMS/C16 as an alkoxysilane precursor. Polymerization was carried out with or without the presence of a base (for example KOH or NaOH) which acts as both a catalyser for epoxide ring opening and as reagent for any geopolymerization of the clays.

For the synthesis, various organic and halogenated solvents can be utilised. Suitable solvents are acetaldehyde, acetic acid, acetylacetone, acetone, acetonitrile, acrylamide, acrylic acid, acrylonitrile, acrolein, iso-amyl alcohol, 2-aminoethanol, iso-amyl acetate, aniline, anisole, benzene, benzonitrile, benzyl alcohol, n-butanol, 1-butanol, 2-butanol, i-butanol, 2-butanone, t-butyl alcohol, iso-butyric acid, n-butyl acetate, iso-butyl acetate, di-n-butyl phthalate, chlorobenzene, carbon disulphide, carbon tetrachloride, chlorobenzene, chloroform, cyclohexane, cyclohexanol, cyclohexanone, p-cymene, n-decane, 1,1-dichloroethane, 1,2-dichloroethane, cis-1,2-dichloroethylene, o-dichlorobenzene, diethylene glycol, diglyme, dimethoxyethane, N, N-dimethylaniline, dimethylformamide (DMF), dimethyl phthalate, dimethyl sulfoxide (DMSO), dioxane, 1,4-dioxane, ethanol, ether, ethyl acetate, ethyl acetoacetate, ethyl acrylate, ethylbenzene, ethyl benzoate, diethyl ether, glycerin, n-heptane, 1-heptanol, n-hexane, 1-hexanol, 2-hexanone, hexamethylphosphoramide (HMPA), hexamethylphosphorous triamide (HMPT), methanol, methacrylic acid, methyl acetate, methyl acrylate, methylcyclopentane, methyl cyclohexane, 2-methylcyclohexanone, methyl methacrylate, methyl t-butyl ether (MTBE), methyl t-methyl chloride, methyl t-chloride methyl, methyl-t-butyl-methyl, acrylonitrile nitriles, n-nonane, 1-octanol, iso-octane, n-octane, pentane, 1-pentanol, 2-pentanol, 3-pentanol, 2-pentanone, 3-pentanone, 1-propanol, 2-propanol, n-propionic acid, iso-propyl acetate, n-propyl acetate, pyridine, styrene, 1,1,1-trichloroethane, 1,1,2-trichloroethane, 1,1,2,2-tetrachloroethane, trichlorethylene, tetrachlorethylene, tetrahydrofuran (THF), toluene, water, heavy water, p-xylene, m-Xylene, o-Xylene, or mixtures thereof.

For the functionalization of the fabric, meanwhile a portion of cotton fabric was impregnated, by dip coating, with the suspension of clay functionalized according to the scheme shown in FIG. 7. In particular, the portion of fabric was dipped in a container containing the suspension of clay which had been functionalized in isopropanol for 2 hours; once this time was complete, the fabric was recovered and desiccated in a stove at 60° C. for two hours.

The development of the reaction between the alkoxysilane and the nanofiller, with or without the presence of fabric, proved to be of key importance and a “bottom-up” process was performed to obtain of a new type of innovative material.

In this sense, 3-glycidoxypropyltrimethoxysilane, GPTMS, has been particularly preferred as an alkoxysilane due to its bifunctionality; indeed, by its trimethoxysilane end, it allows the formation of a sol-gel network, while the epoxide ring is able to undergo nucleophile coupling, with the consequent opening of said ring and formation of a heterolytic covalent bond with the nucleophile. The matrices were obtained preferably by also adding the C16, hexadecyl trimethoxysilane, as a functionalizing alkoxysilane. The sol-gel polymerization reaction was performed both with and without the presence of traces of KOH, so as to promote the potential catalytic opening of the epoxide ring and the geopolymerization reaction of the clays. The clays and the silane precursors utilised were suitably chosen so as to modify the characteristics of the final material, owing to the intrinsic characteristics of the precursors: (i) the stratified nature of the clays to render the material absorbent; (ii) GPTMS and C16 to make the material, respectively, hydrophilic or lipophilic. The innovative hybrid functional materials thus synthetized were tested for absorption and degradation of oil in sea water.

As can be seen from the working examples shown below, it was observed that the material's absorption capacity is greater for the matrix obtained utilizing the Lipari clays (UNESCO world heritage) with an alcoholic sol of GPTMS-C16 in the presence of KOH; excellent results were also achieved for the other natural clays, while neither the commercially available clays or any of the matrices obtained showed the same capacity for absorption and degradation in relation to the oil.

What is evident and represents the most surprising aspect of the present invention is that the functionalization of the natural clays with functional alkoxysilanes proved efficacious and able to result in the formation of nanohybrids, nanocomposites, or geopolymeric materials with implemented structural and morphologic properties.

In particular, the most innovative aspect is the versatility of the material obtained, i.e. the possibility of obtaining geopolymers from locally available clays, the diversity of forms, following environmentally sustainable synthetic procedures and without the use of high temperatures. These materials prove particularly suitable for the absorption and the degradation of oil spills at sea and above all, in line with the circular economy objectives adopted by the EU, they can be recovered and reused for other oil absorption and degradation cycles.

Furthermore, fluorinated chain alkoxysilanes and those with different aliphatic chain lengths were utilised to implement the hydrophobicity of the matrix, and the reaction ratios between the clayey matrix and the functionalizing cross-linking agents were decreased.

By adding instead also alkoxysilanes with a suitable functionality (for example SH, NH₂), it is possible utilize these powders to entrap metal cations and heavy metals (the most common environmental pollutants include: Sn²⁺, Cd²⁺, Zn²⁺, Hg²⁺, Pt²⁺, Cu²⁺) dissolved in aqueous solution.

Other hybrid materials were also developed by performing the same synthetic processes as for the functionalization, i.e. entirely or partially replacing the clays. These additional or alternative carriers to the clays comprise: fruit wastes, urban waste and fine ashes.

The innovative functionalized hybrid material as described above features a high absorbent capacity and induces bioremediation of oil; it floats, just like most of the main competitors' products do, it is recoverable/recyclable, while also offering particular advantages with respect to those currently on the market. In particular, it is based on: 1) use of materials of natural origin (clays or fine ashes) and/or discards/spent waste; 2) green production technology (low temperature and without the use of toxic solvents) and a low environmental impact (low power consumption and zero emissions); 3) totally eco-friendly products which are non-toxic/harmful for the environment or for the marine and avian fauna; 4) recovery of the waste substances absorbed; 5) bio-regenerative capacity thereof (characteristics not present for other types of similar compounds); recovery and recycling of the material, in line with the principles of the circular economy supported by the European Union; 6) high versatility since it can be available in various forms of use (powder, fabrics, sponges) which render it fully applicable in various operative conditions and with different types of contaminants.

Once impregnated with oil, none of the functionalized hybrid materials sink and are easily recovered, without causing further damage to the seabed. This characteristic has proved to be particularly important, because it determines a reduction, by at least 50%, in the cost normally involved.

Furthermore, products were developed in alternative or to complement the functionalized fabrics, such as for example polymeric foams and sponges.

The following table shows examples of these variants:

Furthermore, the products in the Arginare line allow recovery of the waste materials absorbed.

These systems can be utilised as powders or as absorbent panels (also for the cleaning of preparation or storage tanks, or the remediation of polluted areas) or utilised, as they are or as a support for existing technologies in small devices such as intake or discharge filters, in absorbents pads and panels or in floating systems (absorbent powders, booms, socks and pads).

In another aspect, then, the present invention concerns the use of this functionalized hybrid material as an absorbent substrate for hydrocarbons, heavy metals, chemical pollutants, oils, particulate and microplastics, for environmental remediation and recovery.

In this sense, the term “environmental remediation” means the remediation of different matrices, such as water, air, and soil.

In a further aspect, the present invention regards a product for environmental remediation and recovery, comprising said functionalized hybrid material, said product being a fabric, a sponge or a polymeric foam.

In an additional aspect, the present invention regards a method for environmental remediation and recovery, by using the functionalized hybrid material and the product comprising the same.

It should be understood that all the possible combinations of the preferred aspects of the components of the hybrid material disclosed above are described herein and therefore are also preferred.

It should also be understood that all aspects identified as preferred and advantageous for the hybrid material should be deemed similarly preferable and advantageous also for the preparation and the uses of said hybrid material.

Below are working examples of the present invention provided for illustrative purposes.

### EXAMPLES

### Example 1

### Selection of the Clays on the Basis of the Geological Characteristics

The Sicilian clays under examination are named after the area in which thy are mined (FIG. 3), or labelled with codes: i) Lipari 1, ii) Lipari 4, iii) Tracoccia, iv) Baronello and v) Cretazzi.

The clays labelled Lipari 1 and Lipari 4 belong to the Montmorillonite class, while the clays labelled Tracoccia, Baronello and Cretazzi belong to the Illite class (FIG. 4).

Pure clays, meanwhile, are named according to the composition, or they are labelled as follows: i) Montmorillonite-Na (saturated with sodium atoms); ii) Montmorillonite (in which there is water between the layers) and iii) Kaolin (FIG. 5).

The composition of the samples labelled Tracoccia, Baronello and Cretazzi is known and is shown in the table below:

| Composition | Cretazzi | Baronello | Tracoccia |
|---|---|---|---|
| SiO2 | 58.53 | 57.62 | 57.36 |
| TiO₂ | 0.65 | 0.79 | 0.79 |
| Al₂O₃ | 15.57 | 17.15 | 17.39 |
| Fe₂O₃ | 5.60 | 6.63 | 6.55 |
| MnO | 0.06 | 0.12 | 0.09 |
| MgO | 3.82 | 3.49 | 3.44 |
| CaO | 12.15 | 10.02 | 10.39 |
| Na₂O | 0.76 | 1.07 | 0.89 |
| K₂O | 2.72 | 2.95 | 2.93 |
| P₂O₅ | 0.14 | 0.17 | 0.16 |
| Sr | 337 | 387 | 294 |
| V | 105 | 118 | 118 |
| Cr | 75 | 76 | 85 |
| Co | 10 | 10 | 10 |
| Ni | 40 | 34 | 31 |
| Zn | 96 | 87 | 86 |
| Rb | 113 | 111 | 110 |
| Y | 27 | 26 | 24 |
| Zr | 137 | 203 | 189 |
| Nb | 15 | 17 | 16 |
| Ba | 308 | 411 | 293 |
| The | 24 | 26 | 36 |
| Ce | 62 | 58 | 72 |
| Pb | 13 | 16 | 13 |
| Th | 15 | 15 | 15 |

### Preparation of the Samples of Clay

Once reduced to powder form using a mortar, the clays were dispersed according to the method stated in literature (B. N. ROLFE, et to the, “Shorter contributions to general geology”, Geol. Surv. Prof. Pap., 1987, 334, p. 229-271), modified.

The method consists in the dispersion of 10 g clay with 1.5 g salt dispersant (in particular sodium hexametaphosphate) in 1 L of distilled water. This solution underwent ultrasound treatment for 3 minutes, by means of the use of an immersion sonicator, at a power of 130 Watt and 20 kHz.

The dispersion thus obtained was extracted by means of a 50 mL syringe and centrifuged for 10 minutes at 3000 rpm to recover the precipitate therefrom consisting of the fraction of the smallest particles. After being desiccated in the stove at 60° C. for two hours and 24 hours at room temperature, the clays were recovered and partially functionalized.

### Synthetic Procedures

For the functionalization of clays and fabrics, sol-gel suspensions were prepared utilizing the GPTMS or the C16, as functionalizing alkoxysilanes, and nanofillers of an inorganic variety available on the market or sourced in the province of Messina and belonging to the Montmorillonite, Illite and Kaolinite classes. The suspensions thus obtained were then applied to 100% cotton fabrics (C).

The functionalization was performed on dispersed and desiccated clay powders by means of addition of the silanes in a total ratio amounting to three times the weight of the clay; therefore 3 g GPTMS or 1.5 g GPTMS and 1.5 g C16 was added to 1 g clay. The solution was brought to 50 mL with isopropanol (or other organic or halogenated solvents, see appendix titled “List of organic solvents) and treated in both a basic environment (for example with traces of KOH or NaOH), to promote polymerization, and without a base. It was then left for 24 h under stirring in a magnetic stirrer:

| Example 1A | Example 1B | Example 1C | Example 1D |
|---|---|---|---|
| 1 g clay + | 1 g clay + | 1 g clay + | 1 g clay + |
| 3 mL | 1.5 mL | 3 mL | 1.5 mL |
| GPTMS + | GPTMS + | GPTMS + | GPTMS + |
| 50 mL 2- | 1.5 mL C16 + | 50 mL 2- | 1.5 mL C16 + |
| Propanol + | 50 mL 2- | Propanol | 50 mL 2- |
| KOH | Propanol + | | Propanol |
| | KOH | | |

The functionalized clays were separated from the isopropanol and washed three times with pure solvent by means of centrifugation for 10 minutes at 3000 rpm and desiccated in the stove at 60° C. for two hours and at room temperature for 24 hours.

For the functionalization of the fabric, meanwhile, a portion of cotton fabric was immersed in the container containing the suspension of clay functionalized in isopropanol for 2 hours; once this time was complete, the fabric recovered and desiccated in the stove at 60° C. for two hours.

The following table shows the starting clays and the end hybrid materials obtained:

### Example 2

### Experimental Setup to Test for Absorption and Degradation of Oil

The experimentation consists in testing the samples in microcosms (samples+sea water+oil).

In particular, the following was observed:
for the clays, the degree of absorption of the oil, by means of measurement of COD on the sea water for the total organic substance content, and the testing of the hydrocarbon fraction by gas chromatography (GC-FID);
for the fabrics, we analyses the degree of oil absorption again, but also the capacity of the fabrics to retain the oil, again by COD measurements and gas chromatographic testing of the hydrocarbon fraction.

The samples obtained with the technique described above were analysed at the IAMC-CNR (Marine and Coast Environment Institute), Italy.

The clays and the fabrics were tested inside microcosms consisting of 1 L-capacity bottles filled with 500 mL sea water (sea water, SW).

0.1% in volume of oil with respect to the weight of the clays was added, within the bottles; 0.5 mL oil, therefore, to test 500 mg clays, which were also added (within the bottles) immediately after the oil.

To test the fabrics, meanwhile, two types of tests were performed, using again 500 mL of SW, namely:
inside the bottles, a volume of oil amounting to the mass of the fabric was added, on top thereof, in order to assess the absorption thereof;
the oil was pipetted onto the fabric, again amounting in volume to the same as the mass of the fabric, and once enough time had lapsed for the absorption of the drop, it was laid on the surface of the sea water in the bottle, to assess how well the fabric retained the oil.

Before being utilised, the oil was supplemented with internal standard heptamethylnonane, at a rate of 0.1% in volume; therefore, 10 μL of standard was added to 10 mL of oil.

### COD Analysis

In the cuvette from the kit stated above, said 0.6 mL of ultrapure water was added, plus 0.4 mL of the sample taken (1 cm underneath the layer of oil) by means of a Pasteur pipette, for a 1:5 dilution.

The cuvettes were incubated (at a temperature of 100° C. for 1 hour) in the digester. After the predefined incubation period (within 24 hours), the COD measurement (in mg/L) was analysed spectrophotometrically.

### Extraction of the Hydrocarbons

Extractions were performed on the hydrocarbons of the samples under examination by means of washing with dichloromethane solvent. More specifically, the hydrocarbon extractions were carried out on three different matrices: i) water, ii) clays, and iii) fabrics (remembering that in one case the fabrics were impregnated with oil, therefore the retained hydrocarbons were assessed, while in the other case simply absorption was assessed).

For the extraction of the hydrocarbons in the aqueous matrix, the 500 mL sea water was filtered with fibre glass filters to separate the hydrocarbons from the clays or fabrics, and then were treated (3 times) by means of passages (washes) in the separating funnel with 50 mL dichloromethane. The organic fraction was fileted with sodium sulphate to eliminate any traces of water.

The extract obtained was taken to evaporation by means of a continuous nitrogen flow and subsequently dissolved with a small amount of dichloromethane and stored in a 2 mL cuvette for gas chromatographic analysis.

### Gas Chromatographic Analysis (GC-FID)

To test for the degradation of the hydrocarbons of the samples, the following programming was utilised: stove temperature programming 40° C. for 3 minutes, 7° C./minute ramp up to 140° C., 4° C./minute ramp up to 180° C., 5° C./minute ramp up to 325° C., 325° C. isotherm for 14 minutes, total analysis time: 70.28 minutes. The temperatures of the SSL injector and of the flame ionizing detector were 325° C.; the carrier gas, helium, was kept at a constant linear speed of 45 cm/s; the injection was performed in splitless mode for 1 minute and the injection was pulsed at 3.50 bar for 0.30 minutes; the injection volume of the sample was 1 μL of the diluted sample diluted to 1:10 (v/v, extract/dichloromethane).

At the end of the range of the samples, integration of the peaks obtained in the gas chromatograms was carried out using software.

### Results:

### Clay and Fabric Microcosms

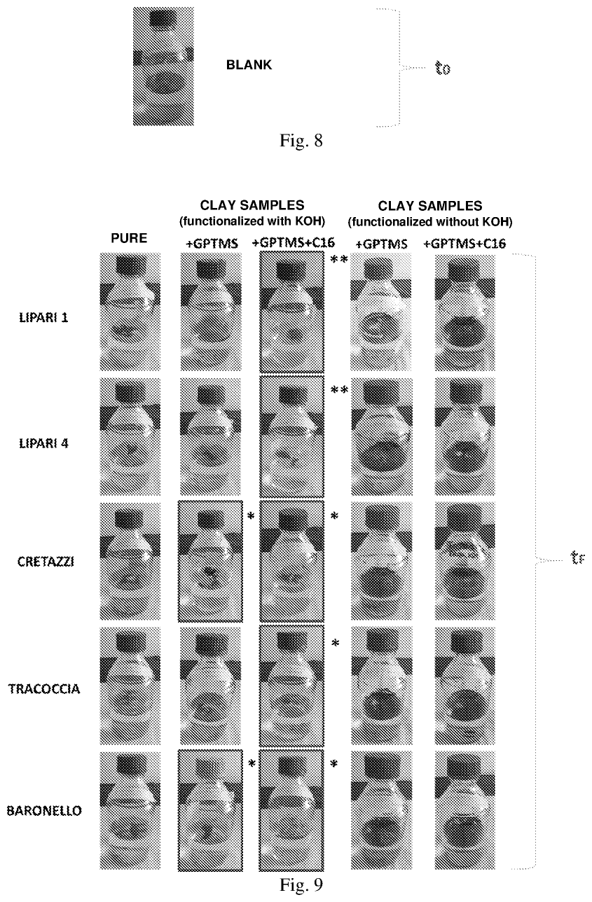

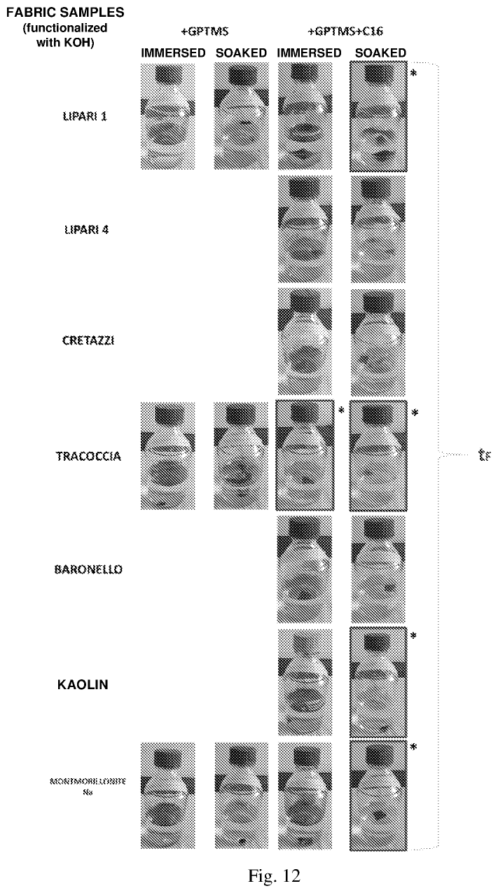

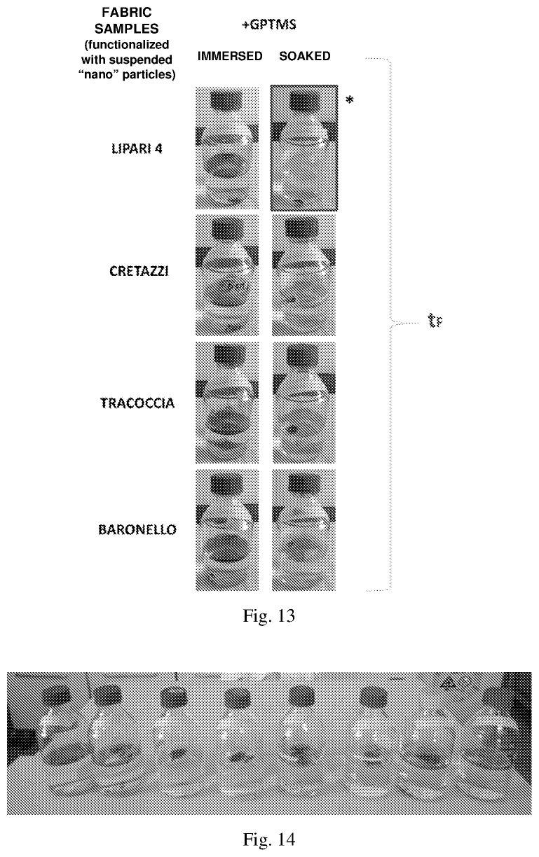

The images relating to the microcosms produced according to the experimental design are illustrated in FIGS. 8-13. The images were made at both time zero (t0, FIG. 8 for the bottle containing only SW and OIL (shown as Blank), and at an end time (tF), corresponding to 7 days of incubation. Furthermore, COD analyses were carried out, plus qualitative and quantitative analysis of the hydrocarbons, to determine the best samples of functional clay and coated fabric. The framed photos show the samples defined, by visual means, as the best absorbents.

In general, the samples functionalized with KOH proved to have a greater absorption of the oil, as the nucleophilic opening of the epoxide ring of the GPTMS by the KOH, improves the affinity of the clays in relation to hydrocarbons. Furthermore, the samples functionalized with KOH underwent geopolymerization which contributed to increasing the absorbent nature thereof, since featuring rigid cavities inside the material ceramic obtained. Different reactivity was observed, furthermore, between the functionalized clays and the non-functionalized clays, since the latter tend to deposit on the bottom, while the former float and completely encapsulate the oil present on the surface of the water, especially those functionalized with the C16.

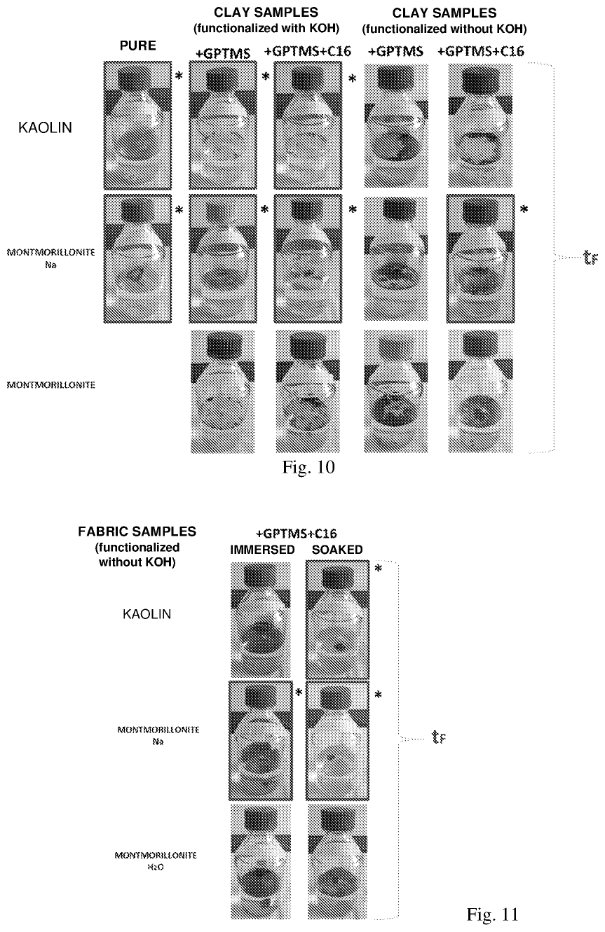

For the fabrics (FIG. 11-13), it was possible to identify which were the best at retaining the oil (by assessing the results of the soaked fabrics), while the samples immersed in the oil did not produce many results given their tendency to sink.

### COD Results

The following tables show the results relating to the COD analysis of the samples selected previously. The images of the microcosms relating to the Sicilian clays are shown in FIG. 14.
COD for the Sicilian clays functionalized with KOH:

| | COD | |
|---|---|---|
| Sample surface | (mg/L) | % |
| CONTROL | 1067.3 | 100.0 |
| OIL + TRA + GPTMS + C16 + KOH | 462.5 | 43.3 |
| OIL + LIP 1 + GPTMS + C16 + KOH | 334.5 | 31.3 |
| OIL + LIP 4 + GPTMS + C16 + KOH | 427 | 40.0 |
| OIL + CRE + GPTMS + C16 + KOH | 534.5 | 50.1 |
| OIL + BAR + GPTMS + C16 + KOH | 732 | 68.6 |
| OIL + CRE + GPTMS + KOH | 619.5 | 58.0 |
| OIL + BAR + GPTMS + KOH | 382.5 | 35.8 |

COD for the pure clays functionalized with KOH and without KOH:

| | COD | |
|---|---|---|
| Sample surface | (mg/L) | % |
| CONTROL | 1067.3 | 100.0 |
| OIL + CAOL | 583 | 54.6 |
| OIL + CAOL + GPTMS + KOH | 440 | 41.2 |
| OIL + C AOL + GPTMS + C16 + KOH | 435 | 40.8 |
| OIL + MONT Na | 467 | 43.8 |
| OIL + MONT Na + GPTMS + KOH | 444 | 41.6 |
| OIL + MONT Na + GPTMS + C16 + KOH | 471 | 44.1 |
| OIL + MONT Na + GPTMS + C16 | 391 | 36.6 |

COD for the fabrics functionalized with KOH and without KOH:

| | COD | |
|---|---|---|
| Sample surface | (mg/L) | % |
| CONTROL | 1067.3 | 100.0 |
| OIL + TRA + GPTMS + C16 + KOH, immersed | 339 | 31.8 |
| OIL + TRA + GPTMS + C16 + KOH, soaked | 281 | 26.3 |
| OIL + LIP 1 + GPTMS + C16 + KOH, soaked | 298 | 27.9 |
| OIL + LIP4 nano + GPTMS + C16 + KOH, | 280 | 26.2 |
| soaked | | |
| OIL + CAOL + GPTMS + C16 + KOH, soaked | 436 | 40.9 |
| OIL + CAOL + GPTMS + C16, soaked | 363 | 34.0 |
| OIL + MONT Na + GPTMS + C16 + KOH, | 318 | 29.8 |
| soaked | | |
| OIL + MONT Na + GPTMS + C16, soaked | 263 | 24.6 |
| OIL + MONT Na + GPTMS + C16, immersed | 355 | 33.3 |

In assessing the photographic documents and the COD values obtained, the best samples proved to be those functionalized both with GPTMS and with C16, in presence of traces of KOH. The samples which showed absolutely the best oil absorption were: “Lipari 1+GPTMS+C16+KOH” and “Lipari 4+GPTMS+C16+KOH”.

For these samples, the GC-FID analysis was carried out on the hydrocarbon fraction absorbed by the clay and the XRD characterization thereof is shown below.

### Results of the GC-FID Analysis of the Hydrocarbons Absorbed

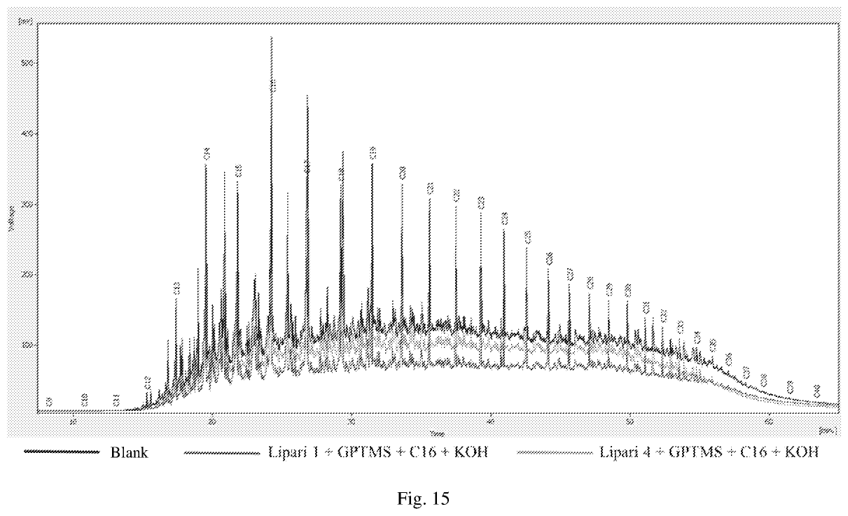

FIG. 15 shows the overlayed gas chromatograms for the samples labelled Blank (outermost line), Lipari 1+GPTMS+C16+KOH (innermost line) and Lipari 4+GPTMS+C16+KOH (intermediary line).

The analyses, as already mentioned, were carried out on the hydrocarbon fraction extracted from the clays.

From the analysis of the three chromatograms of the samples under examination, it is clear that the sample labelled “Lipari 4+GPTMS+C16+KOH” underwent greater degradation with respect to the other samples, in particular with respect to the starting situation (T₀). This variation was verifiable thanks to the peak relating to the internal standard added to the oil before the experimentation (heptamethyl nonane, retention time: 17.843 min) which coincides with the result shown in the gas chromatogram of the Blank; the clear “translation” of the entire chromatogram is due to a biodegradation effect.

The same cannot be said for the sample labelled “Lipari 1+GPTMS+C16+KOH”, where the GC-FID chromatogram proved be overly “translated” with respect to the other two, and effectively also the peak of the heptamethyl nonane does not coincide with the other, as it should do. This is due to both the fact that the clay has probably absorbed less oil than the “Lipari 4+GPTMS+C16+KOH” sample or to possible errors during the extraction; nevertheless, we can still confirm a degradation also for this sample.

The following tables show the main compounds (broken down into linear hydrocarbons and aromatic polycyclic hydrocarbons) detected by GC-FID analysis on the samples under examination:

| Retention | | Retention | |
|---|---|---|---|
| time | Compound | time | Compound |
| [min] | name | [min] | name |
| 8.217 | C9 | 57.03 | C36 |
| 10.777 | C10 | 58.293 | C37 |
| 13.067 | C11 | 59.55 | C38 |
| 17.41 | C13 | 15.043 | Naphthalene |
| 19.55 | C14 | 17.843 | Heptamethylnonane |
| 21.833 | C15 | 20.803 | Acenaphthylene |
| 24.293 | C16 | 21.537 | Acenaphthene |
| 26.773 | C17 | 23.98 | Fluorene |
| 29.223 | C18 | 26.873 | Pristane |
| 31.497 | C19 | 28.77 | Phenanthrene |
| 33.62 | C20 | 29.09 | Anthracene |
| 35.613 | C21 | 29.383 | Phytane |
| 37.493 | C22 | 34.723 | Fluoranthene |
| 39.277 | C23 | 35.797 | Pyrene |
| 40.967 | C24 | 41.763 | Benzo(a)anthracene |
| 42.587 | C25 | 41.97 | Chrysene |
| 44.137 | C26 | 46.67 | Benzo(b)fluoranthene |
| 45.63 | C27 | 47.073 | C28 |
| 48.46 | C29 | 47.177 | Squalene |
| 49.797 | C30 | 47.833 | Benzo(a)pyrene |
| 51.083 | C31 | 52.01 | Dibenzo(a,h)anthracene |
| 53.553 | C33 | 52.147 | Indeno(1,23-c,d)pyrene |
| 54.74 | C34 | 52.88 | Benzo(g,h,i)perylene |

### XRD Characterization of the Clays

Characterization by using the X-ray diffraction technique (2°<<80° step=0.02/s) of the samples of clay utilised allowed to determine their composition.

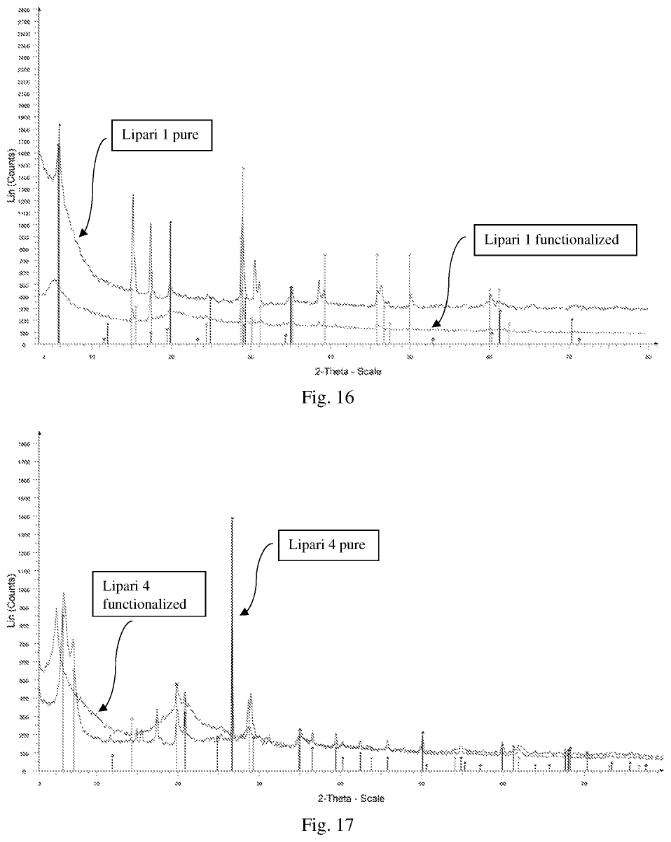

The diffraction spectra for the functionalized clays which gave the best results are shown. FIG. 16 shows the comparison between pure Lipari 1 and Lipari 1+GPTMS+C16+KOH (Lipari 1 functionalized). The Lipari 1 sample proved to be a set of three minerals: saponite, nontronite, and jarosite.

FIG. 17 shows the comparison between Lipari 4 and Lipari 4+GPTMS+C16+KOH (functionalized Lipari 4). The Lipari 4 sample proved to be a set of three minerals: nontronite, quartz, and beidellite. From these spectra it can be inferred how the clays underwent modifications following functionalization.

The first peak detected has underwent a leftwards shift in both the functionalized clays, which describes a probable distancing of the characterizing layers of the mother clay and therefore an internal functionalization thereof, in this way increasing the catalytic surface area thereof. This distancing was also caused by the overall size of the KOH utilised for functionalization.

Going towards the right, the functionalized clays in the spectrum feature a more “bell-like” shape, probably due to the vitrification of the clay caused by a geopolymerization following functionalization.

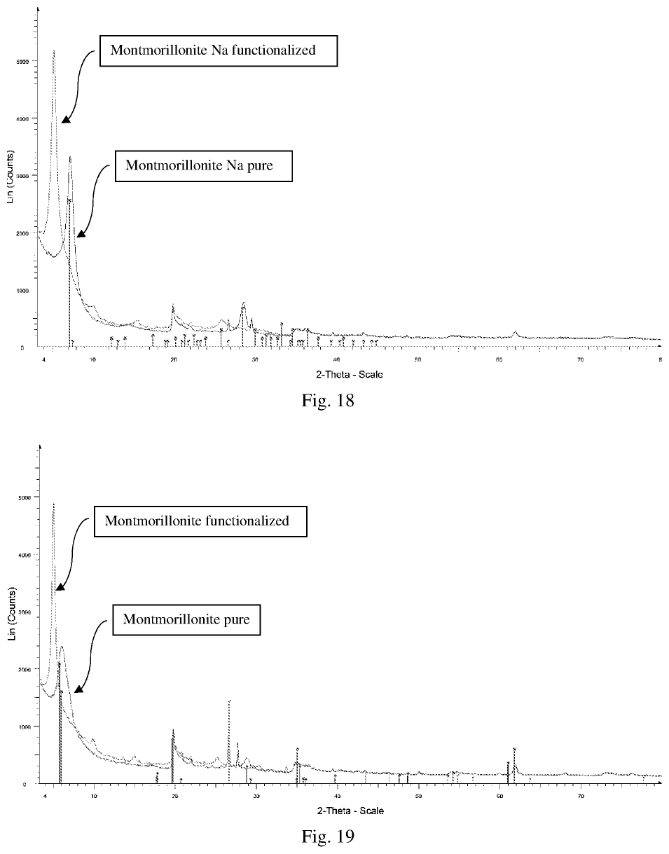

FIG. 18 shows the comparison between pure Montmorillonite Na and Montmorillonite Na+GPTMS+C16+KOH (functionalized Montmorillonite Na).

FIG. 19 shows the comparison between pure Montmorillonite and Montmorillonite GPTMS+C16+KOH (functionalized Montmorillonite).

Thus, such as in FIG. 17, also in FIGS. 18 and 19, the left-wards shift of the main peak of the functionalized clays and the wider more ‘bell-shaped’ appearance of the peaks on the right are indicative of the modifications of the clays functionalized due to a distancing of the layers characterizing the mother clay, with internal functionalization or presence of K+, and the start of geopolymerization thereof.

1. A functionalized hybrid material comprising a starting material selected from clay, fruit waste, urban waste, thin ash and their combinations, said starting material being functionalized with at least 15 wt % of at least an alkoxysilane crosslinking agent, based on the weight of the starting material.

2. The functionalized hybrid material of claim 1, wherein said at least an alkoxysilane crosslinking agent and said starting material are in a weight ratio of 1:5 to 10:1.

3. The functionalized hybrid material of claim 1, wherein said starting material is clay.

4. The functionalized hybrid material of claim 3, wherein said clay is a natural clay and belongs to the class of montmorillonites, illites, kaolinites or chlorites.

5. The functionalized hybrid material of claim 1, wherein said at least an alkoxysilane crosslinking agent is an epoxy trialkoxysilane, preferably is 3-glycidoxypropyltrimethoxysilane.

6. The functionalized hybrid material of claim 1, wherein said at least an alkoxysilane crosslinking agent is an aliphatic trialkoxysilane having formula (I): 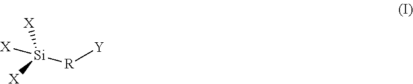
where X is an alkoxy group, R is a C4-C20 aliphatic chain, and Y is a methyl, amino, or thiolic group.

7. The functionalized hybrid material of claim 6, comprising clay functionalized with a mixture of a) at least an epoxy trialkoxysilane and b) at least an aliphatic trialkoxysilane having formula (I), wherein a) and b) are in weight ratio of 5:1 to 1:5.

8. The functionalized hybrid material of claim 7, comprising clay functionalized with a mixture of 3-glycidoxy propyltrimethoxysilane and hexadecyltrimethoxysilane, wherein 3-glycidoxy propyltrimethoxysilane and hexadecyltrimethoxysilane are in weight ratio of 2:1 to 1:2, and wherein said mixture and said clay are in weight ratio of 1:5 to 10:1.

9. A method for environmental recovery and restoration with the functionalized hybrid material of claim 1, said method comprising
absorbing hydrocarbon pollutants and heavy metal on said functionalized hybrid material.

10. Product for the recovery and environmental remediation, comprising the functionalized hybrid material of claim 1, said product being a fabric, a sponge or a polymeric foam.

11. The functionalized hybrid material of claim 1, wherein said at least an alkoxysilane crosslinking agent and said starting material are in a weight ratio of 1:2 to 5:1.

12. The functionalized hybrid material of claim 5, wherein said at least an alkoxysilane crosslinking agent is 3-glycidoxypropyltrimethoxysilane.

13. The functionalized hybrid material of claim 6, wherein said at least an alkoxysilane crosslinking agent is hexadecyl trimethoxysilane.

14. The functionalized hybrid material of claim 7, wherein said mixture and said clay are in weight ratio of 1:2 to 5:1.

15. The functionalized hybrid material of claim 7, wherein said mixture and said clay are in weight ratio of 3:1.
